(19) United States
(12) Patent Application Publication
(10) Pub. No.: US 2008/0248583 A1
(43) Pub. Date: Oct. 9, 2008

(54) Quantitative and Qualitative Chelation Measuring Methods and Materials

(75) Inventors: Clayton Ericson, Morgan, UT (US); Stephen Ashmead, West Haven, UT (US)

Correspondence Address: BRINKS HOFER GILSON & LIONE / ALBION;UTAH OFFICE, 405 SO. MAIN, SUITE 800, SALT LAKE CITY, UT, 84111-3400, US

(73) Assignee: ALBION LABORATORIES, INC., Clearfied, UT (US)

(21) Appl. No.: 11/575,465

(22) PCT Filed: Sep. 16, 2005
(86) PCT No.: PCT/US05/33488

§ 371 Date: Mar. 16, 2007

Related U.S. Application Data
(60) Provisional application No. 60/610,280, filed on Sep. 16, 2004.

(51) Int. Cl. G01N 23/00; C07F 1/08

(52) U.S. Cl. 436/76; 556/33; 556/34

(57) ABSTRACT

The present invention is directed to a method of assaying for the presence or absence of a metal-ligand chelate in a sample containing either a metal-ligand chelate or a free ligand. The method includes (a) reacting the sample with a luminophore to obtain either a metal-ligand-luminophore chelate and/or a ligand-luminophore adduct; (b) detecting the electromagnetic spectrum of the reaction product; (c) matching the electromagnetic spectrum of the reaction product with an electromagnetic spectrum metal-ligand chelate luminophore chelate or the electromagnetic spectrum of a ligandluminophore adduct; (d) correlating a match of the electromagnetic spectrum of the reaction product and the electromagnetic spectrum of the metalligand-luminophore chelate with the presence of a metal-ligand chelate, or correlating a match of the electromagnetic spectrum of the reaction product and the electromagnetic spectrum of the ligand-luminophore adduct with the absence of a metal-ligand chelate.

### TECHNICAL FIELD OF THE INVENTION

The present invention relates to methods and materials that can be used to qualitatively and quantitatively measure chelation of organic compounds with various cationic minerals and specifically, amino acid compounds with various minerals.

### BACKGROUND OF THE INVENTION

Chelates are generally produced by the reaction or association of a ligand with a metal cation resulting in a complex. Amino acid chelates may be made by the reaction of an α-amino acid and metal ion, typically but not necessarily having a valence of two or more, to form a ring structure. In such a reaction, the positive electrical charge of the metal ion is neutralized or delocalized by the electrons available through the carboxylate and or free amino groups of the α-amino acid. The structure, chemistry and bioavailability of amino acid chelates is well documented in the literature, e.g. Ashmead et al., Chelated Mineral Nutrition, (1982), Chas. C. Thomas Publishers, Springfield, Ill.; Ashmead et al., Intestinal Absorption of Metal Ions, (1985), Chas. C. Thomas Publishers, Springfield, Ill.; Ashmead et al., Foliar Feeding of Plants with Amino Acid Chelates, (1986), Noyes Publications, Park Ridge, N.J.

One advantage of amino acid chelates in the field of mineral nutrition is attributed to the fact that these chelates are readily absorbed in the gut and mucosal cells by means of active transport. Chelates enable minerals to be absorbed in biological processes along with amino acids as a single unit utilizing the amino acids as carrier molecules. Therefore, the problems associated with the competition of ions for active sites and the suppression of specific nutritive mineral elements by others can be avoided. This is especially true for compounds such as iron sulfates that are typically delivered in relatively large quantities in order for the body to absorb an appropriate amount. Controlled delivery of nutritional minerals is advantageous because large quantities of those minerals often cause nausea and other discomforts as well as create an undesirable taste.

Since metal amino acid chelates can serve as competitive delivery means for mineral supplements, there is a growing need for methods of characterizing the amino acid chelate. Government regulation and guidelines associated with nutritional manufacturing are prompting the development of techniques to quantify a variety of ingredients. Presently, there is no accepted method for the detection, identification and quantification of metal amino acid chelates by the United States Pharmacopeial Convention (USP), Association of Official Analytical Chemists International (AOAC International), or the United States Food and Drug Administration (FDA). A technique that can detect, identify and quantify a chelate, and specifically metal amino acid chelates, is highly desirable as that technique could be used in the nutritional and feedstock industries to attain reliable comparisons and standards for uniform treatment of nutritional supplements and ingredients. Furthermore, a method of detecting metal chelates would be useful in a variety of contexts including waste water treatment, removing heavy or radioactive elements from waste streams, and characterizing new and novel chelates.

### SUMMARY OF THE INVENTION

The present invention is directed to a method of assaying for the presence or absence of a metal-ligand chelate in a sample containing either a metal-ligand chelate or a free ligand. The method includes (a) reacting the sample with a luminophore to obtain either a metal-ligand-luminophore chelate and/or a ligand-luminophore adduct; (b) detecting the electromagnetic spectrum of the reaction product; (c) matching the electromagnetic spectrum of the reaction product with an electromagnetic spectrum metal-ligand chelate luminophore chelate or the electromagnetic spectrum of a ligand-luminophore adduct; (d) correlating a match of the electromagnetic spectrum of the reaction product and the electromagnetic spectrum of the metal-ligand-luminophore chelate with the presence of a metal-ligand chelate, or correlating a match of the electromagnetic spectrum of the reaction product and the electromagnetic spectrum of the ligand-luminophore adduct with the absence of a metal-ligand chelate.

The methods of the present invention are useful in qualitatively and quantitatively characterizing a metal amino acid complex or chelate. To qualitatively assay for the presence or absence of a metal-ligand chelate, a luminophore is added to the sample where the luminophore is capable or reacting with either a metal-ligand chelate, free ligand, or both. The resulting mixture displays an electromagnetic signature and that signature can be correlated with the presence or absence of a metal-ligand chelate. To quantitatively assay for the amount of a metal-ligand chelate in a sample, a luminophore is added to the sample where the luminophore is capable of reacting with either a metal-ligand chelate, free ligand, or both. The resulting mixture displays an electromagnetic absorbance pattern which can be detected and correlated with the amount of a metal-ligand chelate present in the sample.

The methods of the invention also permit an investigator to determine whether a ligand, not known to be capable of binding a metal, can bind to a metal. This method involves contacting the metal with a test ligand to form a test composition under conditions permitting binding of ligands known to bind to the metal, contacting the test composition and test ligand with a luminophore to form a test sample, detecting an electromagnetic signature of the sample and thereby determine whether the test ligand binds the metal.

The methods of characterizing a metal chelate and specifically metal amino acid chelates can include reacting a ligand with a chromophoric molecule, obtaining an electromagnetic spectrum of the ligand-chromophoric product, reacting a metal-ligand chelate with a chromophoric molecule, obtaining an electromagnetic spectrum of the metal-ligand-chromophoric product, and comparing the two electromagnetic spectra.

The methods of characterizing a metal amino acid complex or chelate can include both the ultraviolet and infrared segments of the electromagnetic spectrum including the visible region. A non-limiting example is reacting an amino acid with a chromophoric molecule, obtaining an infrared spectrum of the amino acid, chromophoric products, reacting a metal amino acid complex with a chromophoric molecule, obtaining an infrared spectrum of the metal amino acid complex, chromophoric products, and comparing the two infrared spectrums.

In particular embodiments, the chromophoric molecule is selected from ninhydrin, benzo[f]ninhydrin, benzo[f]furoninhydrin, 5-(4-nitrophenyl)ninhydrin, 5-methoxy-ninhydrin, 5-(methylthio)ninhydrin, thieno[f]ninhydrin, 5-phenyl- and 5-thienylninhidrin derivatives including 5-(2-thienyl)ninhydrin (2-THIN), 5-(3-thienyl)ninhydrin (3-THIN), and benzoflavanone analogues. In other particular embodiments, the chromophoric molecule is 1,8-diazaflourenone (DFO). In more particular embodiments, the chromophoric molecule is ninhydrin.

In some embodiments, the ligand can be any ligand capable of forming a chelate with a metal. More preferred ligands are the α-amino acids which are the primary components of proteins, selected from the naturally occurring amino acids such as alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, and valine. In other embodiments, the amino acid may be selected from 4-hydroxyproline, 5-hydroxylysine, homoserine, homocysteine, ornithine, β-alanine, γ-aminobutyric acid (GABA), statine and statin. In still other embodiments, the amino acid is selected from the non-natural amino acids. In some embodiments, the amino acids are selected from amino acids where the R group has non-nucleophilic groups. In some embodiments, the amino acids are selected from amino acids where the R group has one or more functional groups that are less nucleophilic than the amino group of the amino acid. In some embodiments, at least one ligand is an amino acid and another ligand is selected from the group consisting of: citric acid, ascorbic acid, acetic acid, lactic acid, malic acid, succinic acid, and combinations thereof.

In particular embodiments, the metal is selected from alkaline, alkaline earth, transition, and rare earth, basic, and semi-metals which can coordinate with a chromophore. In more particular embodiments, the metal is selected from boron, calcium, chromium, cobalt, copper, iron, magnesium, manganese, molybdenum, potassium, selenium, vanadium, and zinc.

Compositions of the invention include luminophore metal-ligand chelate adducts of the Formula: (Mₐ)^{e+}(Lum)_{b}(L)_{c}(H₂O)_{d}, where M is a metal, Lum is a luminophore, L is any suitable ligand capable of binding to a metal, a is 1 or 2, b is 1, 2, 3, or 4, c is 1, 2, 3, or 4, d is 0, 1, 2, 3, 4, 5, 6, 7, or 8, and e is 0, 1, 2, 3, 4, 5, 6, 7, or 8.

### BRIEF DESCRIPTION OF THE DRAWINGS

FIG. 1 is a UV absorption spectrum of the reaction product of ninhydrin with zinc bisglycinate.

FIG. 2 is overlaid UV absorption spectra for a solution of zinc bisglycinate, glycine and ninhydrin and a solution of glycine and ninhydrin.

FIG. 3 is a graph of UV absorption where zinc bisglycinate and ninhydrin were reacted at different pH values.

FIG. 4 is a graph of UV absorption where zinc bisglycinate and ninhydrin were reacted at different temperatures.

FIG. 5 is a graph of 370 nm absorption values where zinc bisglycinate and ninhydrin were reacted at different time intervals.

FIG. 6 is a graph of 570 nm absorption values for glycine reaction with ninhydrin.

FIG. 7 is a graph of 570 nm absorption values for glycine reaction with ninhydrin with glycine additions.

FIG. 8 is a graph of 570 nm absorption values for glycine reaction with ninhydrin measured at different time intervals.

FIGS. 9a and 9b are graphs of 570 and 370 nm absorption values, respectively, for glycine reaction with ninhydrin at various pH values at various zinc bisglycinate concentrations.

FIG. 10 is FT-IR spectra for zinc bisglycinate dried from solutions at different pH values.

FIG. 11 is a speciation prediction graph for zinc and glycine at various pH values.

FIG. 12 is a graph of UV absorption for zinc bisglycinate and sodium EDTA at various EDTA to zinc ratios.

FIG. 13 is a graph of absorbance at 375 nm for copper bisglycinate and copper glycinate.

FIG. 14 is a graph of UV absorption at 570 nm for 1.0 mg/mL and 2.5 mg/mL solutions at various reaction time intervals.

FIG. 15 is a proposed structure for zinc bisglycinate ninhydrin complex.

### DETAILED DESCRIPTION OF THE INVENTION

The term “chelate” as used herein means a molecular entity containing a central metal associated with at least one bidentate ligand and optionally associated with one or more mono- or multi-dentate ligands. In the interaction between the central metal and any of the ligands, the bonds between the ligand and the central metal can include covalent bonds, ionic bonds, and/or coordinate covalent bonds.

The term “chelate ring” as used herein means the atoms of the ligand and central metal which form a heterocyclic ring with the metal as the closing member. In the interaction between the central metal and a multidentate ligand, one or more chelate rings of from 3 to 8 members can exist. Typically, the chelate ring will be of from 5 to 6 members.

The term “ligand” as used herein means a molecular group that is associated with a central metal atom. The ligand can be any ligand capable of forming a chelate with a metal. The terms monodentate, bidentate (or didentate), tridentate, tetradentate, and multidentate are used to indicate the number of potential binding sites of the ligand. For example, a carboxylic acid can be a bidentate or other multidentate ligand because it has at least two binding sites, the carboxyl oxygen and hydroxyl oxygen. An amino acid can have at least two binding sites and many amino acids will have multiple binding sites including the amino nitrogen and the carboxyl oxygen and hydroxyl oxygen atoms of a carboxylic acid functional group. When the side chain of the amino acid has one or more heteroatoms, the side chain may also present additional binding sites. Examples of ligands include those with primary or secondary amines and more preferred ligands are those with primary amines. Other examples of ligands are those with primary or secondary amines and a carboxylic acid, each of which is α to a common carbon atom. Representative ligands include but are not limited to the α-amino acids which include the selected from the naturally occurring amino acids commonly found in biological structures including alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, and valine. In some examples, the amino acid ligands may be selected from alanine, glycine, histidine, isoleucine, leucine, methionine, phenylalanine, serine, tryptophan, and valine. Other ligands include the amino acids 4-hydroxyproline, 5-hydroxylysine, homoserine, homocysteine, ornithine, β-alanine, γ-aminobutyric acid (GABA), statine, ornithine, and statin. In other embodiments, the amino acid is selected from the non-natural amino acids. In preferred embodiments, the amino acid is selected from the aliphatic naturally occurring amino acids selected from alanine, glycine, isoleucine, leucine, proline, and valine. Where the R side chain of an amino acid has a functional group which would be more nucleophilic than the primary amine of the amino acid, then a protecting group can be present on that side chain functional group. For example, the primary amine of the R side chain for lysine may be protected by formaldehyde prior to addition of a chromophore. The term ligand thus includes modified ligands which may also called protected ligands. Amino acids ligands can be the L-amino acids, the D-amino acids, or a racemic mixture. Preferably, the amino acids are the L-amino acids.

The term “cryptand” as used herein means a molecular entity comprising a cyclic or polycyclic assembly of binding sites that contain three or more binding sites held together by covalent bonds, and which defines a molecular cavity in such a way as to bind another molecular entity, the guest, more strongly than do the separate parts of the assembly. The adduct thus formed is called a cryptate. Monocyclic ligand assemblies such as crowns and some cyclic peptides can be included in this group. Polycyclic ligand assemblies such as some cyclic peptides can be included in this group.

As applied in the field of mineral nutrition, there are at least two chelated products which are commercially utilized. The first is referred to as a “metal proteinate.” The American Association of Feed Control Officials (AAFCO) has defined a “metal proteinate” as the product resulting from the chelation of a soluble salt with amino acids and/or partially hydrolyzed protein. Such products are referred to as the specific metal proteinate, e.g., copper proteinate, zinc proteinate, etc. These metal proteinates also include at least one chelate ring.

The second product, referred to as an “amino acid chelate,” when properly formed, is a stable product having one or more five-membered rings formed by a reaction between the amino acid and the metal. Specifically, one of the carboxylic acid oxygens and the α-amino group of the amino acid each bond with the metal ion. Such a five-membered ring is defined by the metal atom, the carboxyl oxygen, the carbonyl carbon, the α-carbon and the α-amino nitrogen. The actual structure will depend upon the ligand to metal mole ratio and whether the carboxyl oxygen forms a coordinate covalent bond or an ionic bond with the metal ion. Generally, the ligand to metal molar ratio is at least 1:1 and is preferably 2:1 or 3:1. However, in certain instances, the ratio may be 4:1. Most typically, an amino acid chelate may be represented at a ligand to metal molar ratio of 2:1 according to Formula 1 as follows:

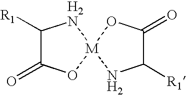

where R₁ and R₁′ are organic radicals, substituents or functional groups. R₁ and R₁′ can be the same or different.

In the above formula, the dashed lines can represent coordinate covalent bonds, covalent bonds, and/or ionic bonds. Further, when R₁ is H, the chelating agent is an amino acid, glycine that is the simplest of the α-amino acids. However, R₁ could be representative of any other side chain. Where the chelating agent is one of the naturally occurring α-amino acids, the R₁ side chains have been described as aliphatic which includes but is not limited to alanine, glycine, isoleucine, leucine, proline, and valine; aromatic which includes but is not limited to phenylalanine, tryptophan, tyrosine; acidic which includes but is not limited to aspartic acid, and glutamic acid; basic which includes but is not limited to arginine, histidine, and lysine; hydroxylic which includes but is not limited to serine, and threonine; sulfur-containing which includes but is not limited to cysteine, and methionine; amidic (containing amide group) which includes but is not limited to asparagine, and glutamine. R₁ could also be representative of any other side chain resulting in any of the non-natural occurring amino acids. Many of the amino acids have the same configuration for the positioning of the carboxylic acid oxygens and the α-amino nitrogen with respect to the metal ion. In other words, the chelate ring can be defined by the same atoms in each instance, even though the R₁ side chain group may vary. In some embodiments, amino acids with non-nucleophilic R groups include alanine, glycine, histidine, isoleucine, leucine, methionine, phenylalanine, serine, tryptophan, and valine.

The term “metal” as used herein means any alkaline, alkaline earth, transition, and rare earth, basic, and semi-metals which can coordinate with a luminophore. Metal includes nutritional minerals. Representative metals include the transition, lanthanide, and actinide metals. In more particular embodiments, the metal has d-orbitals capable of interacting with a ligand. Preferred metals are selected from boron, calcium, chromium, cobalt, copper, iron, magnesium, manganese, molybdenum, potassium, selenium, vanadium, and zinc.

The term “nutritionally acceptable metal” as used herein means metals that are known to be needed by living organisms, particularly plants and mammals, including humans. Metals such as boron, calcium, chromium, cobalt, copper, iron, magnesium, manganese, molybdenum, potassium, selenium, vanadium, and zinc among others are exemplary of nutritionally acceptable metals.

The terms “hydrate” or “n-hydrate” as used herein means a molecular entity with some degree of hydration, where n is an integer representing the number of waters of hydration, e.g., monohydrate, dihydrate, trihydrate, tetrahydrate, pentahydrate, hexahydrate, septahydrate, octahydrate, nonahydrate, etc.

An “amino acid chelate” is defined as the product resulting from the reaction of a metal or metal ion from a soluble metal salt with amino acids having a mole ratio of one mole of metal to one to four (preferably two) moles of amino acids to form coordinate covalent bonds. The average weight of the hydrolyzed amino acids is approximately 150 and the resulting molecular weight of the chelate will typically not exceed a molecular weight of about 800 amu and more frequently less than about 1000 amu. The chelate products are identified by the specific metal forming the chelate, e.g., iron amino acid chelate, copper amino acid chelate, etc.

The reason a metal atom can accept bonds over and above the oxidation state of the metal is due to the nature of chelation. For example, at the α-amino group of an amino acid, the nitrogen contributes both lone-pair electrons used in the bonding to the metal. These electrons fill available d-orbitals of the metal forming a coordinate covalent bond. In this state, the unfilled orbitals in the metal can be satisfied by both bonding electrons from lone pair electrons as well as electrons from ionic species. The chelate can be completely satisfied by the bonding electrons and the charge on the metal atom (as well as on the overall molecule) can still be zero. As stated previously, it is possible that the metal ion be bonded to the carboxyl oxygen by either coordinate covalent bonds or ionic bonds. However, the metal ion is preferably bonded to the α-amino group by coordinate covalent bonds only.

Proteinates can be formed using dipeptides, tripeptides, tetrapeptides, polypeptides. Larger ligands have a molecular weight which is too great for direct assimilation of the chelate formed. Generally, peptide ligands will be derived by the hydrolysis of protein. However, peptides prepared by conventional synthetic techniques or genetic engineering can also be used. When a ligand is a di- or tripeptide, a radical of the formula [C(O)CHR₁NH]_{g} H will replace one of the hydrogens attached to the nitrogen atom in Formula 1. R₁, as defined in Formula 1, can be H, or the residue of any other naturally occurring amino acid and g can be an integer of 1, 2 or 3. When g is 1 the ligand will be a dipeptide, when g is 2 the ligand will be a tripeptide and so forth. Amino acid chelates can also include cyclic peptides ligands such as those peptides which can act as cryptands.

The term “heteroatom” as used herein means nitrogen, oxygen, or sulfur.

The term “halogen” as used herein means bromine, chlorine, fluorine, or iodine.

The phrases “measuring a first electromagnetic spectrum” and “measuring a second electromagnetic spectrum” as used herein means using an spectrometer or other optical device to examine an absorbance or emission and also a visual measurement by an operator with the naked eye.

The term “adduct” as used herein means a new chemical species AB, each molecular entity of which is formed by direct combination of two separate molecular entities A and B in such a way that there is change in connectivity. Stoichiometries other than 1:1 are possible, e.g. a bis-adduct (2:1).

The term “luminophore” as used herein means a molecular entity that when present increases the ability of a molecule or atom to luminesce and includes chromophore, fluorophores, and the like.

The term “chromophore” as used herein means a molecular entity capable of selective light absorption resulting in the coloration of an atom or molecule. Chromophores include organic molecules with a conjugated π system, the molecule being capable of coordinating with a metal or an organic molecule which when reacted with a primary amine chelated to a metal also intramolecularly associates with that metal while presenting a characterizable electromagnetic spectrum. For qualitative characterizations, the chromophore should have a profile of electromagnetic absorption or emission in the visible range from about 380 nm to about 740 nm. For quantitative characterizations, the chromophore should have a profile of electromagnetic absorption in a spectroscopically observable range such as infrared, fluorescent, and/or ultraviolet ranges. Chromophores useful in the methods and compositions of the invention can include compounds of Formulas 2-9 where Y is O, S, or Se, Z is any conjugated π system, and W and W′ are each any unbridged conjugated π system and may be the same or different, R₂, R₃, R₄, and R₅ are each independently selected from unsaturated alkyl (alkylene and alkylyne) and aryl, cyano, imino, azo, carbonyl, amide, nitro, isocyanate, isothiocyanate, T is C or a heteroatom, Aₙ and Bₘ are independently selected from unsaturated alkyl and aryl, n and m are independently the value of 0 or 1. Preferred chromophores are those where Z, W, W′, R₂, R₃, R₄, and R₅ are aryl or substituted aryl. It should be appreciated by one skilled in the art that compositions of Formulas 2, 4, 6, 8, 10, and 12 can be in equilibrium with compositions of Formulas 3, 5, 7, 9, 11, and 13, respectively, in the presence of H₂Y, in particular water where Y is O. An illustrative example is the equilibrium that exists between 1,2,3-indantrione and ninhydrin. Because hydration is reversible, compounds of this type exhibit carbonyl-like chemical reactivity. Where Y is S, compounds of this type exhibit sulfonyl-like chemical reactivity.

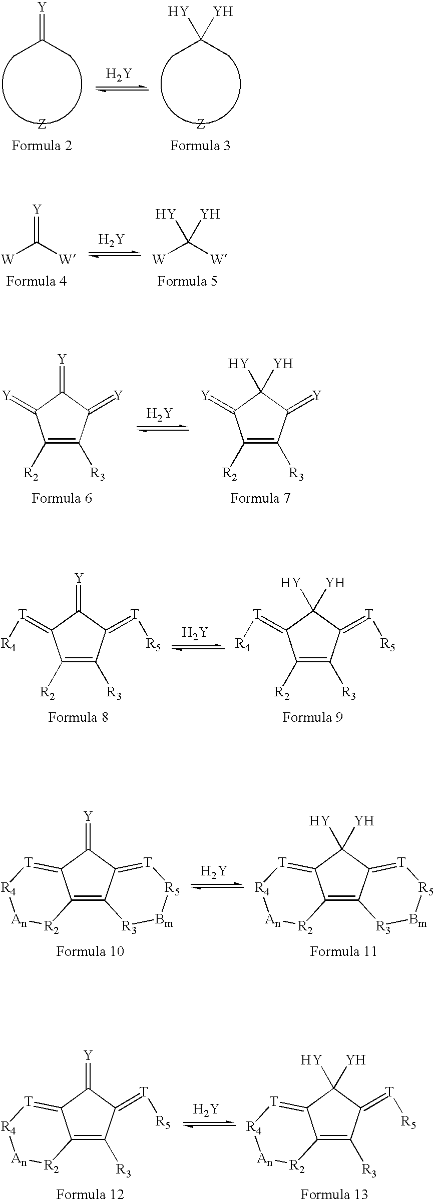

Representative chromophores include ninhydrin, benzo[f]ninhydrin (2,2-dihydroxy-1H-cyclopenta[b]naphthalene-1,3(2H)-dione), benzo[f]furoninhydrin, 5-(4-nitrophenyl)ninhydrin, 5-methoxy-ninhydrin (2,2-dihydroxy-5-methoxy-1H-indene-1,3(2H)-dione), 5-(methylthio)ninhydrin, thieno[f]ninhydrin, 5-phenyl- and 5-thienylninhidrin derivatives including 5-(2-thienyl)ninhydrin (2-THIN), 5-(3-thienyl)ninhydrin (3-THIN), and benzoflavanone analogues. Fluorescent chromophores include but are not limited to 1,8-diazaflourenone (DFO). A preferred chromophore is a ninhydrin analog and a more preferred chromophore is ninhydrin. Determination of chromophores that coordinate with metal ions can be readily determined by one skilled in the art.

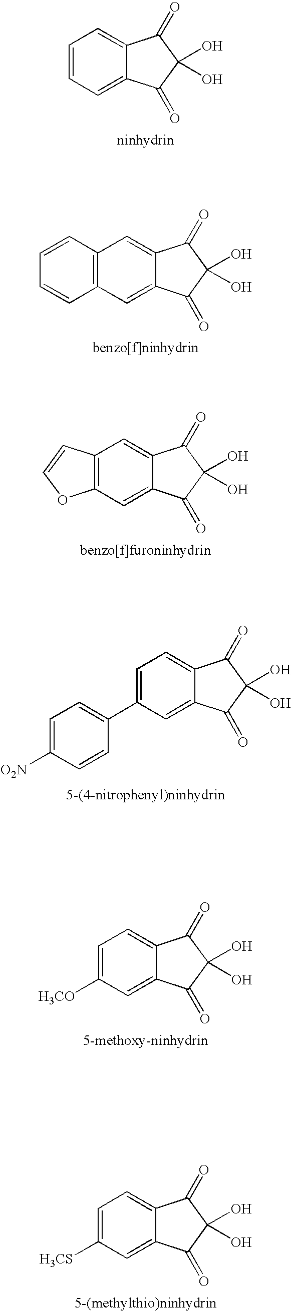

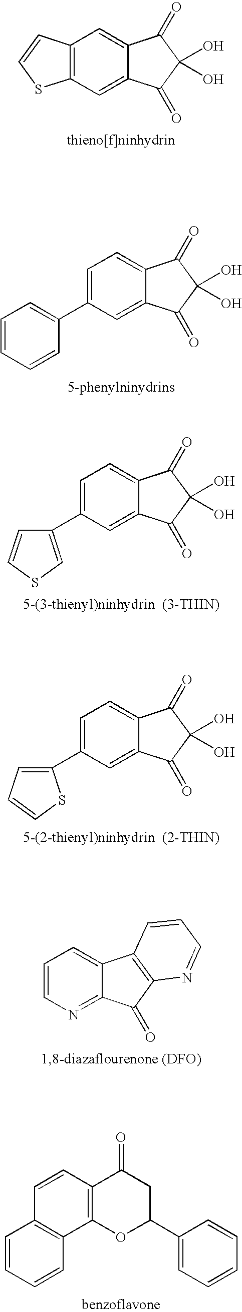

Additional chromophores include croconic acid (4,5-dihydroxy-4-cyclopentene-1,2,3-trione), hexaketocyclohexane (1,2,3,4,5,6-cyclohexanehexone), and rhodizonic acid dihydrate (5,6-dihydroxy-5-cyclohexene-1,2,3,4-tetrone).

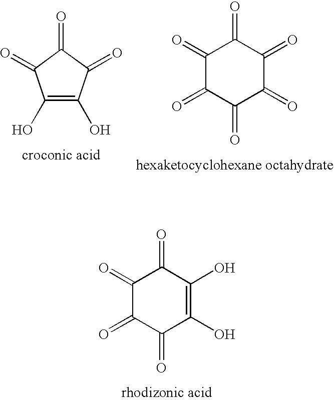

The terms “fluorophore” and “fluorophor” as used herein mean a molecular entity with at least one excited molecule or group that emits photons and is fluorescent.

The term “colorimeter” as used herein means any of various instruments used to determine or specify colors, as by comparison with spectroscopic or visual standards. Colorimeters may measure the concentration of a known constituent of a solution by comparison with colors of standard solutions of that same constituent.

The term “conjugated π system” as used herein means a molecular entity whose structure may be represented as a system of alternating single and multiple bonds: e.g. CH₂═CH—CH═CH₂, CH₂═CH—C≡N. In such systems, conjugation is the interaction of one p-orbital with another across an intervening σ-bond in such structures. (In appropriate molecular entities d-orbitals may be involved.) The term is also extended to the analogous interaction involving a p-orbital containing an unshared electron pair, e.g.: Cl—CH═CH₂. Preferred chromophores are those where the conjugated 71 system is aromatic.

Conjugated π systems include unsaturated alkyl groups having two or more carbons with 1 or more sites of unsaturation, the groups being known as alkenyl groups or radicals and alkynyl groups or radicals. Alkenyl groups are analogous to alkyl groups which are saturated, but have at least one double bond (two adjacent sp² carbon atoms). Depending on the placement of a double bond and substituents, if any, the geometry of the double bond may be trans (E), or cis (Z). Similarly, alkynyl groups have at least one triple bond (two adjacent sp carbon atoms). Unsaturated alkenyl or alkynyl groups may have one or more double or triple bonds, respectively, or a mixture thereof. Unsaturated groups may be straight chain or branched.

Examples of alkenyls include vinyl, allyl and the like. Examples of dialkenes include but are not limited to propandiene (allene), 1,3-butadiene, 1,3-pentadiene, 2-methyl-1,3-butadiene (isoprene), 1,3-hexadiene, 2,4-hexadiene, 2,3-dimethyl-1,3-butadiene, 2-methyl-1,3-pentadiene, 4-methyl-1,3-pentadiene, 3-methyl-1,3-pentadiene, 2,4-dimethyl-1,3-pentadiene and the like. Examples of trialkenes include but are not limited to 2,6-dimethyl-2,4,6-octatriene (neo-alloocimene), 2,6-dimethyl-2,4,6-octatriene, 1,3,5-undecatriene and the like. Examples of alkynyls include, but are not limited to 1-butyne, 2-butyne, 1-pentyne, 2-pentyne, 4-methyl-pent-1-yne, 1-hexyne, 2-hexyne, 3,3-dimethyl-1-butyne, 1-heptyne, 2-heptyne, 5-methyl-1-hexyne, 1-octyne, 2-octyne, 1-nonyne, 1-decyne, 1-dodecyne, 1-pentadecyne and the like. Alkenyl and alkynl groups may be unsubstituted or substituted. Examples of cycloalkenes include but are not limited to 5-isopropyl-2-methyl-1,3-cyclohexadiene, 1-isopropyl-4-methyl-1,3-cyclohexadiene, 1,2,3,4,5-pentamethyl-1,3-cyclopentadiene, 5-isopropyl-2-methyl-1,3-cyclohexadiene, 1,2,3,4-tetramethyl-1,3-cyclopentadiene and the like.

Conjugated π systems also include mixed alkenyl and alkynl groups. An unsaturated hydrocarbon may thus include subunits of double bonds and subunits of triple bonds. Examples of these mixed alkenyl and alkynl groups include 2-methyl-1-buten-3-yne, 2-methyl-1-hexen-3-yne and the like. Mixed alkenyl and alkynl groups may be unsubstituted or substituted.

Conjugated π systems also include aryl groups or radicals. The term “aryl” as used herein means an aromatic carbocyclic ring having from 6 to 14 carbon atoms. Illustrative examples of an aryl group or radical include phenyl, 1-naphthyl, 2-naphthyl, 1-anthryl, 2-antrhyl, 9-anthryl, 1-phenanthryl, 2-phenanthryl, 3-phenanthryl, 4-phenanthryl, 5-phenanthryl, and the like; including fused ring systems with rings that have less than 6 carbons such as 1-acenaphthyl, 3-acenaphthyl, 4-acenaphthyl, 5-acenaphthyl, 1-azulyl, 2-azulyl, 4-azulyl, 5-azulyl, 6-azulyl and the like. Aryl groups may be unsubstituted or substituted.

The term “aryl” also includes heteroaryls. The term “heteroaryl” as used herein means an unsaturated monocyclic group or radical of 5 or 6 atoms, an unsaturated fused bicyclic group or radical of from 8 to 10 atoms, or an unsaturated fused tricyclic group or radical of from 11 to 14 atoms, the cyclic groups having 1 or 2 heteroatoms independently selected from O, N, or S. Illustrative examples of monocyclic heteroaryl include 2- or 3-thienyl, 2- or 3-furanyl, 1-, 2-, or 3-pyrrolyl, 1-, 2-, or 4-imidazolyl, 1-, 3-, or 4-pyrazolyl, 2-, 4-, or 5-oxazolyl, 2-, 4-, or 5-thiazolyl, 3-, 4-, or 5-isoxazolyl, 3-, 4-, or 5-isothiazolyl, 2-, 3-, or 4-pyridinyl, 3- or 4-pyridazinyl, 2- or 3-pyrazinyl, and 2-, 4-, or 5-pyrimidinyl. Illustrative examples of bicyclic heteroaryl include 2-, 3-, 4-, 5-, 6-, 7-, or 8-quinolinyl, 1-, 3-, 4-, 5-, 6-, 7-, or 8-isoquinolinyl, 1-, 2-, 3-, 4-, 5-, 6-, or 7-indolyl, 2-, 3-, 4-, 5-, 6-, or 7-benzo[b]thienyl, 2-, 4-, 5-, 6-, or 7-benzofuran, 2-, 4-, 5-, 6-, or 7-benzoxazolyl, 2-, 4-, 5-, 6-, or 7-benzothiazolyl, and 1-, 2-, 3-, 4-, 5-, 6-, or 7-benzimidazolyl. Illustrative examples of tricyclic heteroaryl include 1-, 2-, 3-, or 4-dibenzofuranyl, 1-, 2-, 3-, or 4-dibenzothienyl, and 1-, 2-, 3-, 4-, 5-, 6-, 7-, 8-, or 9-(1,2,3,4-tetrahydroacridinyl). Heteroaryl groups may be unsubstituted or substituted.

As used above, a fused bicyclic group or radical is a group wherein two ring systems share two and only two atoms. As used above, a fused tricyclic group or radical is a group wherein three ring systems share four and only four atoms.

The term “ligand-luminophore adduct” as used herein means the reaction product made from reacting a ligand with a luminophore but which does not sever the adduct into different molecular species and may be represented by the general Formula Mₐ(Lum)_{b}(L)_{c}. An example of a ligand-luminophore adduct would be the intermediate product of reacting ninhydrin and glycine before a decarboxylation. Subsets of the ligand-luminophore adducts would be ligand-chromophore adducts and ligand-fluorophore adducts.

The term “polyligated” as used herein means 2 or more ligands associated or bound to a metal.

A method of assaying for the presence or absence of a metal-ligand chelate in a sample, wherein the sample contains either a metal-ligand chelate or a free ligand, comprising: (a) reacting the sample with a luminophore to obtain a reaction product, wherein the reaction of the luminophore with a sample containing a metal-ligand chelate produces a metal-ligand-luminophore chelate and the reaction of the luminophore with a sample containing free ligand produces a ligand-luminophore adduct; (b) detecting the electromagnetic spectrum of the reaction product; (c) matching the electromagnetic spectrum of the reaction product with an electromagnetic spectrum metal-ligand chelate luminophore chelate, or matching the electromagnetic spectrum of the reaction product with an electromagnetic spectrum of a ligand-luminophore adduct; (d) correlating a match of the electromagnetic spectrum of the reaction product and the electromagnetic spectrum of the metal-ligand-luminophore chelate with the presence of a metal-ligand chelate, or correlating a match of the electromagnetic spectrum of the reaction product and the electromagnetic spectrum of the ligand-luminophore adduct with the absence of a metal-ligand chelate.

A change detectable in practicing the present invention could include a measured wavelength and or a change in the intensity of a wavelength. Such change may also be a difference in concentration according to Beer's law.

The ligand may be a carbohydrate including selected from the group consisting of: glucose, sucrose, glucosamine, and combinations thereof. Typically, at least one ligand must be an amino acid and other ligands of the chelate may be carbohydrates, and other ligands capable of chelating to a metal.

Ninhydrin (triketohydrindene hydrate) reacts with many amino acids asparagine (R group includes an amide), glutamine (R group includes an amide), arginine (R group includes a guanidine), proline (cyclic secondary amine), hydroxyproline (cyclic secondary amine with alcohol), to form a colored product known as Ruhemann's purple. Some amino acids, notably proline and hydroxyproline do not result in Ruhemann's purple, but have been reported to yield a red colored product. Ninhydrin has been one of the principal qualitative indicators for identifying amino acids in unknown organic materials. The reaction pathway for ninhydrin's reaction with amino acids has been described previously and is depicted in Scheme 1. R₁ represents the side chain of an amino acid. Ruhemann's purple is visibly perceptible with a UV/Visible λ maxima at 405 and 570 nm that is quantifiable in accordance with Beer's law. The intermediate product displayed before the decarboxylation step is an example of a ligand-luminophore-adduct and a ligand-chromophore adduct.

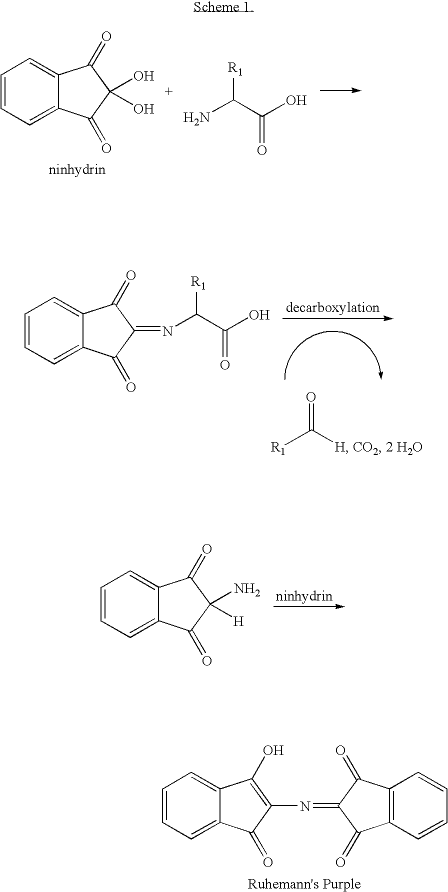

Asparagine is an amino acid with an amide functional group on the end of the side chain (R₁ is CH₂(CO)NH₂) that may interact with ninhydrin in conjunction with the α-amino group to form a ninhydrin asparagine adduct with a modified double ring structure via an intermolecular condensation reaction followed by a intramolecular cyclization step. The proposed modified ring structure for the ninhydrin asparagine adduct is shown in Scheme 2.

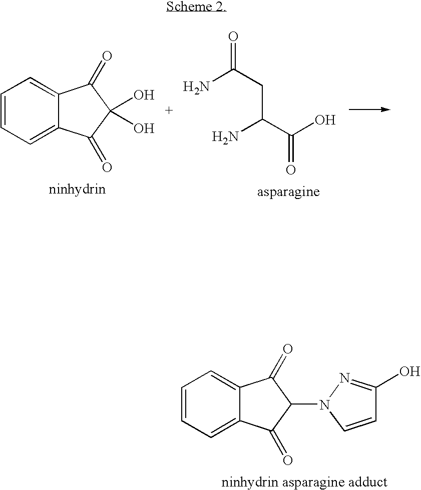

Quantification of the ninhydrin asparagine adduct was conducted by Sheng, et. al., Anal. Biochem., 211, 242-249 (1993) in the range of 50 pM to 50 mM asparagine, and was quantifiable despite the presence of a high background of other amino acids or mixtures of amino acids. This test is specific, sensitive, simple and inexpensive for the identification and quantification of asparagine. Analogously, arginine and glutamine could result in similar ninhydrin adduct products.

Proline chromophore adducts and hydroxyproline chromophore adducts may also vary from other α-amino acids because the R group of proline is directly connected to the amino group forming an aliphatic cyclic amine. While the α-amine of the amino acid of other amino acids can react twice in an intermolecular step followed by second intermolecular step with two equivalents of ninhydrin, the α-amine of proline, a secondary amine, and its analogs (often called α-imino acids) can only react with one equivalent of ninhydrin (and other chromophores) in an intermolecular step.

The reaction pathway of a non-chelated amino acid with ninhydrin as previously described and depicted in Scheme 1 results in product with a visibly detected absorption of 570 nm. Surprisingly, the reaction pathway of a metal- or mineral-amino acid chelate with ninhydrin as depicted in Scheme 3 does not result in a reaction product with an absorption of 570 nm. Instead, a complex other than Ruhemann's purple forms with a different absorption wavelength. It has been discovered that ninhydrin does not complete the known reaction pathway with an amino acid when that amino acid is chelated to a metal. Chelation of the amino group to the metal can stop the reaction before a decarboxylation step would be expected to occur. In effect, the reaction pathway stops at the decarboxylation step depicted in Scheme 1; and, a second chromophore does not react with the chromophore ligand adduct.

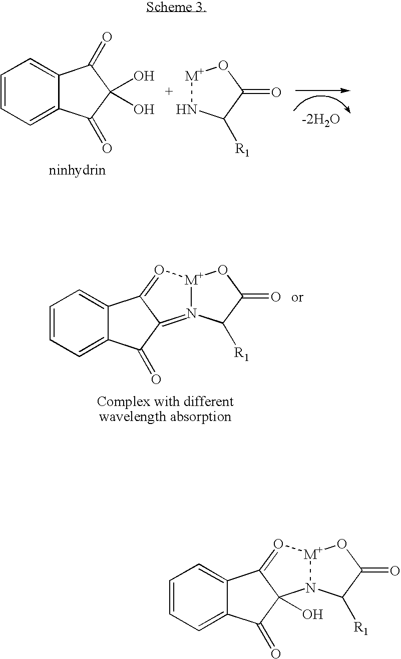

In the methods used to characterize amino acid chelates contemplated by the invention, it is unnecessary that the identity of the ligand or ligands be known. In examples where the chromophore is ninhydrin or ninhydrin-like, many of the amino acids may react via the α-amine. In other examples where the R₁ side chain possesses a heteroatom or heteroatoms that are more nucleophilic than the amine, luminophore adducts and chromophore adducts like the ninhydrin asparagine adduct are can be detected qualitatively and quantitatively. In the latter examples, the reaction pathway may be similar to the reaction scheme shown in Scheme 3 so that Ruhemann's purple does not form.

### Qualitative Assesments

In general, a method for quantitatively and/or qualitatively assaying for the presence or absence of a metal-ligand chelate analyte in a sample includes the steps of a) adding to the sample a luminophore capable of reacting with one or more of i) a metal-ligand chelate to produce an electromagnetic signature characteristic of a metal-ligand chelate luminophore adduct and ii) a free ligand to produce an electromagnetic signature characteristic of a free ligand-luminophore adduct; b) detecting the electromagnetic signature of the sample with the luminophore; and, c) correlating the electromagnetic signature with the presence or absence of the metal-ligand chelate.

The information obtained from this method can reveal information about the sample and a suspected metal-ligand chelate analyte in the sample. By way of examples, the method may reveal that the electromagnetic signature of the sample matches the electromagnetic signature of the metal-ligand chelate luminophore adduct; therefore, the metal-ligand chelate was in the sample. The method may reveal that the electromagnetic signature of the sample does not include the electromagnetic signature of the free ligand-luminophore adduct; therefore, the metal-ligand chelate was in the sample. The method may reveal that the electromagnetic signature of the sample includes the electromagnetic signature of the metal-ligand chelate luminophore adduct and the electromagnetic signature of the free ligand-luminophore adduct; therefore, the metal-ligand chelate and the free ligand were both in the sample. The method may reveal that the electromagnetic signature of the sample matches the electromagnetic signature of the free ligand-luminophore adduct; therefore, the metal-ligand chelate was not in the sample. The method may reveal that the electromagnetic signature of the sample matches the electromagnetic signature of the free ligand-luminophore adduct; therefore, the free ligand was in the sample.

In an alternative method, the free ligand-luminophore adduct further reacts to form an adduct decomposition product which also has an electromagnetic signature characteristic of an adduct decomposition product. In such a case, the method may reveal that the electromagnetic signature of the sample matches the electromagnetic signature of the adduct decomposition product; therefore, the metal-ligand chelate was not in the sample. This method may also reveal that the electromagnetic signature of the sample matches the electromagnetic signature of the adduct decomposition product; therefore, the free ligand was in the sample.

These and other methods contemplated by this disclosure include luminophores that are chromophores and fluorophores.

### Quantitative Assessments

In general, a method for quantitatively assaying for the amount of a metal-ligand chelate analyte in a sample includes the steps of a) adding to the sample a luminophore capable of reacting with one or more of: i) a metal-ligand chelate to produce a metal-ligand chelate luminophore adduct electromagnetic absorbance and ii) a free ligand to produce a free ligand-luminophore adduct electromagnetic absorbance; b) detecting the sample electromagnetic absorbance; and, c) correlating the electromagnetic absorbance of the sample with the amount of a metal-ligand chelate present in the sample.

### Applications of Beer's Law

This quantitative method may be carried out in the context of Beer's law by determining the amount of a in metal-ligand chelate from at least one of the metal-ligand chelate luminophore adduct electromagnetic absorbance and the free ligand-luminophore adduct electromagnetic absorbance.

A spectrophotometer is a device that measures the amount of light (electromagnetic radiation) a solution (sample) absorbs. An example of an applicable spectrophotometer used to carry out one of the methods of the invention is called a colorimeter. A colorimeter can be used to measure the amount of light that a sample absorbs. When a sample is placed into the path of an electromagnetic ray, that sample will absorb a quantity of energy from that ray and either allow some of the ray to pass or transmit the remaining energy. The amount of transmitted energy is generally less than the amount of incident energy.

A detector within the colorimeter measures the amount of light transmitted and can report the percentage of light transmitted relative to the incident light. The amount of light energy a sample absorbs (not transmitted) can be found by applying Beer's law: A=εbc, where A is absorbance (no units, since A=log₁₀P₀/P, and can be expressed in terms of transmittance: A=2−log₁₀% T), ε is the molar absorptivity with units of L mol⁻¹ cm⁻¹ (also referred to as an extinction coefficient of a substance at a measured wavelength), b is the path length of the sample (the path length of the cuvette in which the sample is contained usually expressed in centimeters), and c is the concentration of the analyte in solution, expressed in mol L⁻¹. Following this relationship, the amount of light that a solution absorbs is directly proportional to an analyte concentration.

The concentration of metal-ligand chelate can be determined by measuring a mass of a sample, measuring the absorbance of the sample in the colorimeter with a known cell path length, applying the molar absorptivity of a metal-ligand-luminophore adduct and solving for the concentration. Alternatively, the concentration of metal-ligand chelate can be determined by measuring a mass of a sample, measuring the absorbance of the sample in the colorimeter with a known cell path length, applying the molar absorptivity of a free ligand-luminophore adduct and solving for the concentration. The concentration and mass of the free ligand-luminophore adduct can then be subtracted from the total mass of the sample to solve for the mass of the metal-ligand chelate.

The method of quantitatively assaying for the amount of a metal-ligand chelate analyte in a sample may also include a step for determining the molar absorptivity of the metal-ligand chelate luminophore adduct. In another example, the quantitative method may include a step for determining the molar absorptivity of the free ligand-luminophore adduct.

### Standard & Sample Addition

In some situations, the chelate or analyte of interest is not isolated from other components in a sample. A matrix is everything in the sample except the analyte. Certain components may interfere with an analysis of the amount of the chelate present by either enhancing or depressing the analytical signal. This enhancement or depression is referred to as a matrix effect. To overcome matrix effects, a standard addition technique may be used to measure the amount of chelate present in a multi-component sample. Standard addition techniques involve the use of the unknown and the unknown plus one or more known amounts of a standard.

The sample addition method is may be used in the same way as standard addition, except that a small volume of sample is added to a larger volume of standard. One advantage of this method over standard addition is that the sample matrix is less or irrelevant. Furthermore, the pure standard solution is always measured first so that the operator can ensure that all measurements are made within the optimum linear range for the analysis instrument. Typically, sample addition is of more utility when only small amounts of sample are available, or for highly concentrated samples, or those with a complex matrix. The absorbance is first measured with a measured volume of the pristine standard. Then a measured volume of sample (or the diluted sample) is added, the solutions are mixed well, and a second measurement is taken and compared with the first measurement to calculate the concentration of the sample.

In yet another embodiment, the quantitative method may be carried out by employing standard and sample addition techniques. Such a method may include determining the amount of a metal-ligand chelate from at least one of the metal-ligand chelate luminophore adduct electromagnetic absorbance and the free ligand-luminophore adduct electromagnetic absorbance using standard addition. In one example, a known amount of the metal-ligand chelate is added to the sample and an electromagnetic signature with the spiked amount of known analyte is obtained. In another example, a known amount of the free ligand is added to the sample and an electromagnetic signature with the spiked amount of known free ligand is obtained. In yet another example, a known amount of the metal-ligand chelate luminophore adduct is added to the sample and an electromagnetic signature with the spiked amount of known metal-ligand chelate luminophore adduct is obtained. In still another example, a known amount of the free ligand-luminophore adduct is added to the sample and an electromagnetic signature with the spiked amount of the free ligand-luminophore adduct is obtained.

### Research Tool Method

In another mode of the invention, a method for determining whether a ligand, not known to be capable of binding a metal can bind to a metal includes the steps: a) contacting a metal with a test ligand to form a test composition under conditions permitting binding of ligands known to bind to the metal; b) contacting the test composition and test ligand with a luminophore to form a test sample; c) detecting an electromagnetic signature of the sample; and, d) thereby determining whether the test ligand binds to the metal. In one example, the magnetic signature of the sample with a luminophore provides a visual indication of chelation.

### EXAMPLES

A representative metal amino acid chelate was used to illustrate the method of using a chromophore to characterize a metal chelate. Zinc bisglycinate chelate was reacted with ninhydrin to form a yellow colored solution with λ max at 370 nm. It was found that optimal conditions for the procedure were to mix the reactants at a pH range of 6-8, at room temperature (25° C.), and for a reaction time of 2 hours. Under these optimal conditions, absorption and color at 370 nm fades after 3 hours.

Crystalline zinc bisglycinate (ZnBGly, CAS Reg. No.: 1428 1-83-5) was obtained from Albion Laboratories, Inc. (Clearfield, Utah). X-ray crystallographic analysis has substantiated the structure of zinc bisglycinate as an amino acid chelate. The bonding geometry observed from the x-ray analysis was tetrahedral with evidence of bonding from both the α-carbonyl and α-amino groups with the zinc metal. The zinc bisglycinate chelate was also verifiably observed using FT-IR. See U.S. patent application Ser. No. 10/245,826 filed 12 Sep. 2002, incorporated in its entirety by reference.

Copper bisglycinate chelate was synthesized by combining one mole of Cu(II) sulfate pentahydrate (ACS reagent grade, Sigma Chemical Co., St. Louis, Mo.) with 2 moles of glycine (Ultrapure grade, Sigma Chemical) in an aqueous environment. After the ingredients were reacted as indicated by a color change to a deep blue color, a solution containing 1 mole of barium hydroxide (ACS reagent, Sigma Chemical Co.) was added to purify the copper chelate by precipitating the sulfate from the copper as barium sulfate. The resulting slurry was vacuum filtered and the barium sulfate was washed with distilled water twice to remove all remaining traces of the copper bisglycinate compound. The barium sulfate precipitate was discarded and the copper bisglycinate solution was dried at 70° C. for a period of 72 hours in a Fisher Isotemp Oven (Fisher Scientific, Houston, Tex.). After drying, the copper bisglycinate was ground and identified as a amino acid chelate via FT-IR and the amount of copper chelated was determined via FT-IR to be in excess of 95%.

Solutions of both amino acid chelates were prepared by dissolving 1 mg of each chelate per 1 ml of distilled water. In addition a ninhydrin solution was prepared with a concentration of 20 mg ninhydrin per 1 ml of distilled water. The ninhydrin solution was prepared weekly as needed, and stored in an aluminum foil-swapped, sealed volumetric flask. Test solutions were made by combining a 10 mL aliquot of the amino acid chelate solution with 1 mL of the ninhydrin solution and diluted using distilled water to 100 mL in a volumetric flask. A control solution of glycine (UltraPure, Sigma Chemical Co.) was also made to contain equivalent amounts of glycine that was used in the formation of the chelates that were in the amino acid chelate solutions.

A test matrix of temperature, pH and time variables was set up to examine the effects of varying each variable. Temperatures at which experiments were conducted included room temperature (25° C.), 37° C., and 50-80° C. in 10° C. increments. For the 37° C. trials, an incubator (Fisher Scientific, Houston, Tex.) was used to control temperature. For the 50-80° C. temperature ranges, a water bath was used to control temperature. The pH of the solutions was adjusted from 2-11 in whole pH increments using 0.1 M HCl or NaOH solutions. Time intervals between observations were 10 minutes during a 4 hour period.

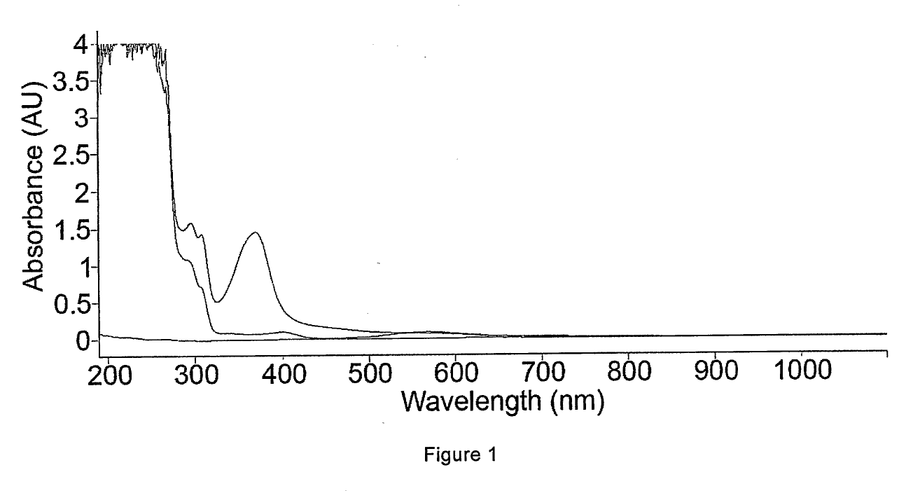

All test samples were scanned with an HIP 8543 UV/Visible spectrophotometer equipped with a photodiode array, quartz flow-through cell, and autosampler. Samples were scanned from 200-900 nm and absorbance recorded 370 and 570 nm. These wavelengths were chosen based upon absorption peaks for Ruhemann's purple and scans were made of a Zn bisglycinate chelate and ninhydrin solutions. When the ZnBGly was combined with ninhydrin in solution, a yellow color developed and was observed to be similar to the color when asparagine was reacted with ninhydrin. The spectral scan showed no evidence of the absorption peaks associated with Ruhemann's purple and indicated a maximum absorbance at 370 nm and not 340-350 nm. Spectra for the ZnBGly-ninhydrin reaction product and a glycine control is shown in FIG. 1.

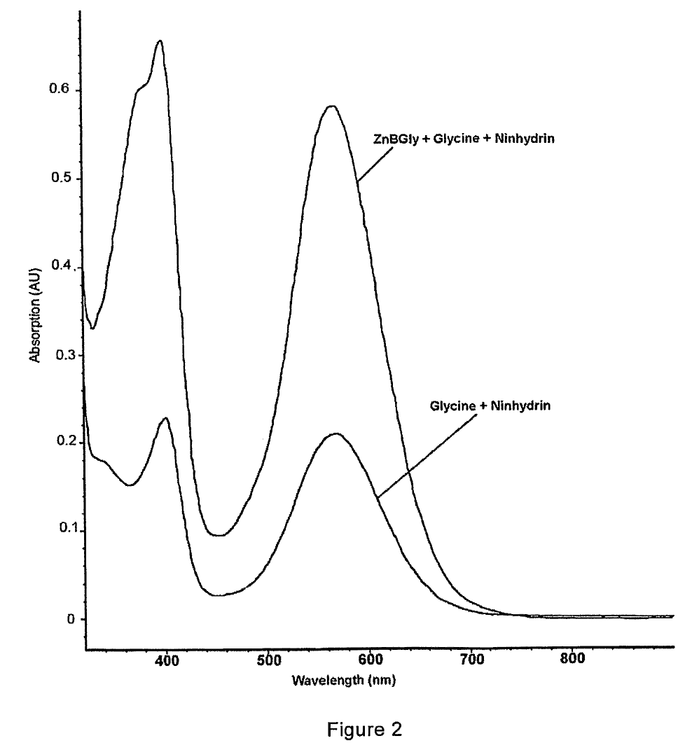

To determine whether the λ max for the ZnBGly ninhydrin adduct and the glycine ninhydrin adduct products have resolvable spectra, an experiment was conducted using both ZnBGly and free glycine together in solution. Accordingly, 10 mL aliquots of 1 mg/1 mL ZnBGly and 1 mg/1 mL glycine were mixed with 2 mL of 1 mg/1 mL ninhydrin solution. The resulting reaction produced clear visible indication of the Ruhemann's purple, although it was somewhat muted (less absorbance) from the glycine alone solution. The UV spectrum for the products was obtained and is shown as FIG. 2. The overlaid spectra shows resolution between the absorptions of 370 nm and 570 nm.

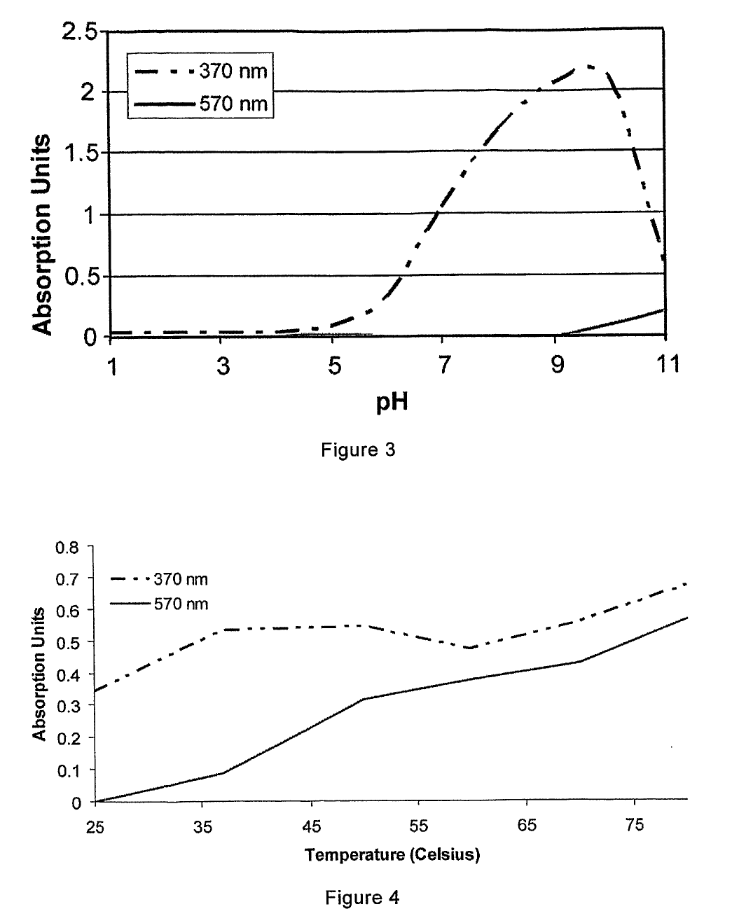

It was also observed that the pH of the test solution also affects the ninhydrin reaction. When a solution of ninhydrin is combined with a solution of ZnBGly, there is a wide pH range of the solution in which Ruhemann's purple is not observable. The formation of a qualitative indication, i.e. the yellow color at 370 nm, was observed in the pH range of from about 5 to about 10. Without wishing to be bound by a particular theory, it is believed that since pH 10 corresponds to the pKb of glycine, a pH of the solution greater than about 10 favors disassociation of the amine group from the zinc thus disrupting the chelate and allowing complete reaction of free glycine and ninhydrin. Several experiments were conducted where time and temperature variables were held constant but pH was adjusted. The results of these experiments are shown in FIG. 3 which shows a plot of absorption units at various pH values. A pH range of from about 6 to about 9 is a preferable range in which to look for qualitatively or measure absorption quantitatively the reaction products of mixing ZnBGly with ninhydrin. pH values below about 6 range do not exhibit Ruhemann's purple color development. Again, without wishing to be bound by a particular theory, it is believed that at pH values less than about 6, ninhydrin and glycine are unable to react. Control experiments were conducted in which free glycine (0.1 mg/mL) was mixed with ninhydrin at various pH values of 4, 7, and 10. Absorption of the ninhydrin glycine mixture was 0.06 absorption units at both pH 4 and 7 but climbed to 0.19 absorption units at pH 10.

Temperature also affects the reaction of ninhydrin with chelates. Without wishing to be bound by a particular theory, it is believed that with increasing temperature, reaction products may breakdown and increase the levels of Ruhemann's purple. It was observed that absorption at 570 nm occurred when the reaction temperature was 37° C. and absorption increased at each higher temperature point tested. FIG. 4 shows the absorption of solutions zinc bisglycinate reacted with ninhydrin after 45 minutes at pH 7 at various temperatures.

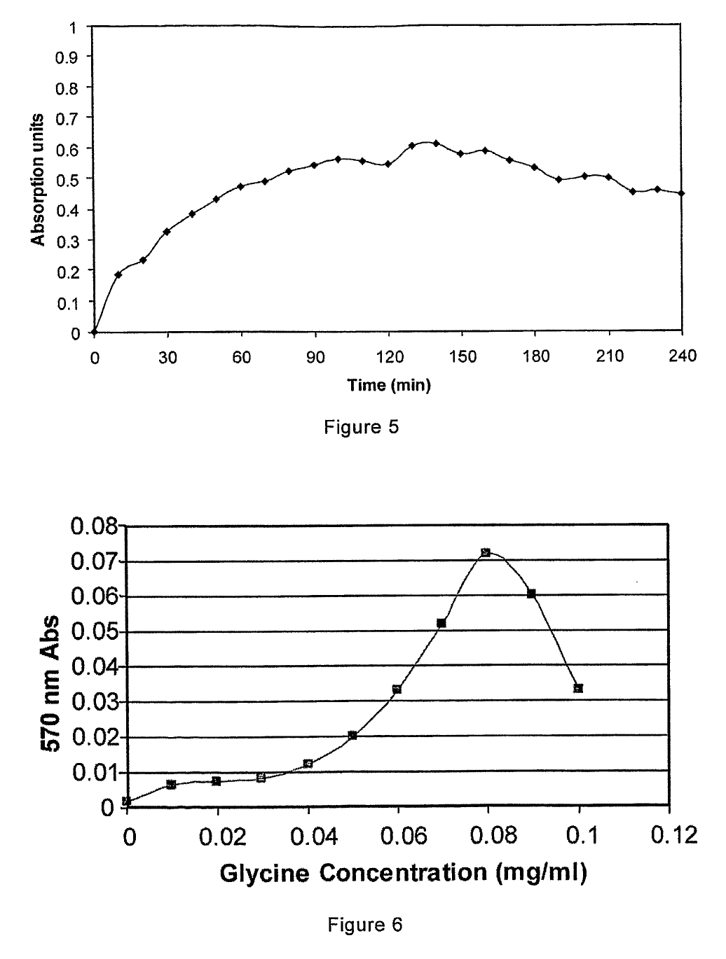

It was further observed that the duration of reaction time also affects the absorption measurements. In those solutions that developed Ruhemann's purple, the purple color would fade with time and show an increasingly gray tone. Borosilicate glass tubes were used to hold the test solutions for the spectrophotometer's autosampler. Without wishing to be bound by a particular theory, it is believed that ultraviolet energy from the lighting of the laboratory may degrade ninhydrin. Ninhydrin is known to degrade upon UV exposure. Ninhydrin degradation may be prevented with use of UV opaque plastic tubes or amber glass tubes. It was also noted during the temperature trials, that yellow color would develop immediately upon mixing the chelate and ninhydrin, especially at higher temperatures. From the data obtained, it appears that there is a incubation period (of between 120 and 180 minutes) for maximal color development (absorption) at 370 nm followed by a breakdown of the zinc bisglycinate-ninhydrin complex. FIG. 5 shows the data plot of absorption at various time increments.

Based upon the results of the pH, temperature, and time assays for ZnBGly, the optimal condition ranges for conducting ninhydrin chelate reactions are a pH of about 6 to about 9, a reaction time of about 2 to about 3 hours, and a temperature of about 25 to about 37° C. The preferred parameter for analysis of ZnBGly is a pH of 7, with a reaction time of 2 hours at a temperature of 25° C.

Based upon the preferred parameters for detection and quantification of ZnBGly, a mixed sample of ZnBGly and glycine was analyzed at 370 and 570 nm. In this experiment, the concentration of the ZnBGly aliquots ranged in descending concentration from 0.1 mg/mL to 0.0 mg/mL in 0.01 mg/mL increments. Simultaneously, free glycine aliquots ranged in ascending concentration from 0.0 mg/mL to 0.1 mg/mL in 0.01 mg/mL increments. The total of the two combined analytes would not exceed 0.1 mg/mL in each test solution. To each solution was added an excess of ninhydrin and the resulting reaction was allowed to stand at room temperature at a pH of 7 for two hours. The samples were then analyzed at 370 and 570 nm. It was found that the ZnBGly ninhydrin adduct absorption at 370 nm decreased linearly, as would be expected (R²=0.99). The glycine ninhydrin adduct absorption at 570 nm did not respond in a linear increment as was expected. The absorbance at 570 nm was near background levels until the concentration of glycine exceeded 0.06 mg/mL. At 0.09 mg/mL the absorbance decreased and the absorbance dropped even further when the glycine concentration reached 0.1 mg/mL. Repeated experiments produced similar results and the data for the experiments is shown in FIG. 6.

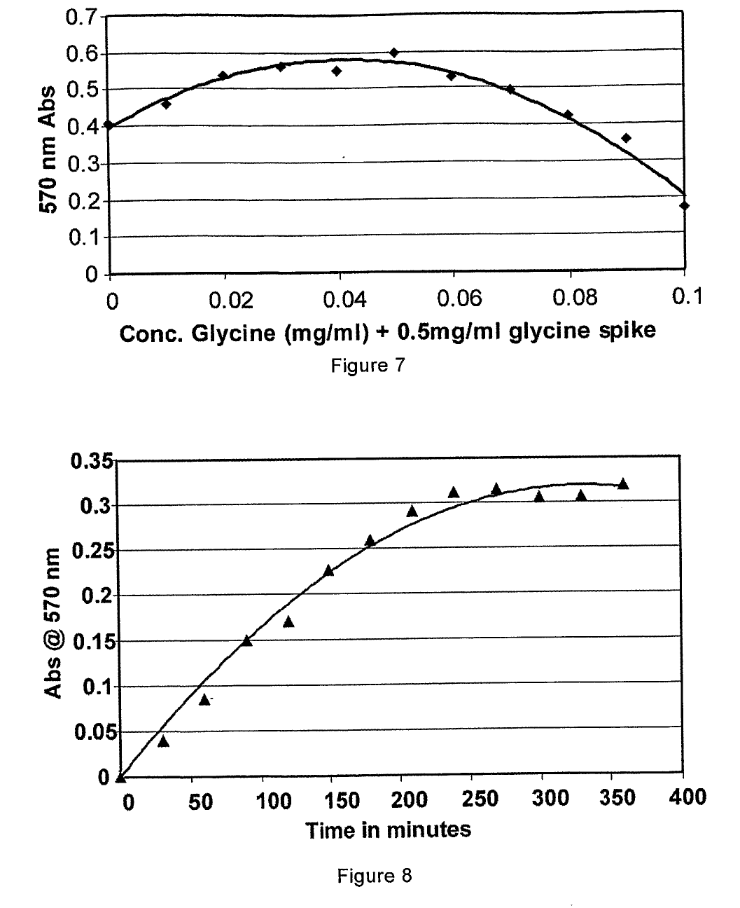

Another experiment was performed using the same aliquots and concentrations of ZnBGly and glycine as used in the previously described experiment. To each sample, 0.5 mg of free glycine was added prior to the addition of ninhydrin. The spiked samples were then allowed to react with excess ninhydrin under the same time, temperature and pH conditions as used before. The results of this spiked glycine assay are shown in FIG. 7.

The results of the combined glycine ZnBGly ninhydrin assays suggest that there may be a matrix effect of assaying for both unbound glycine and a glycine chelate in the same solution using ninhydrin as an indicator. This would increase the difficulty in quantitatively determining in a single assay for the free amino acid in a sample that is purported to include the glycine chelate. The chelate assay continues to result in a linear relationship for absorption at 370 nm and concentration ZnBGly.

Additional experiments were conducted to explore the potential matrix effect arising from assays containing free glycine and glycine metal chelates mixtures. A 1% (wt/wt %) glycine solution was allowed to react with ninhydrin over time. The absorbance at 570 nm was measured every 30 minutes for a period of 6 hours. The results are shown in FIG. 8 and show that nearly complete reaction resulting in the 570 nm absorption does not fully develop for approximately 4 hours. The yellow color absorption at 370 nm is fully developed after 2 hours and was observed to decrease after 2 hours. It was also observed that a gray color also began to develop after 2 hours and may also indicate the development of the purple absorption at 570 nm.

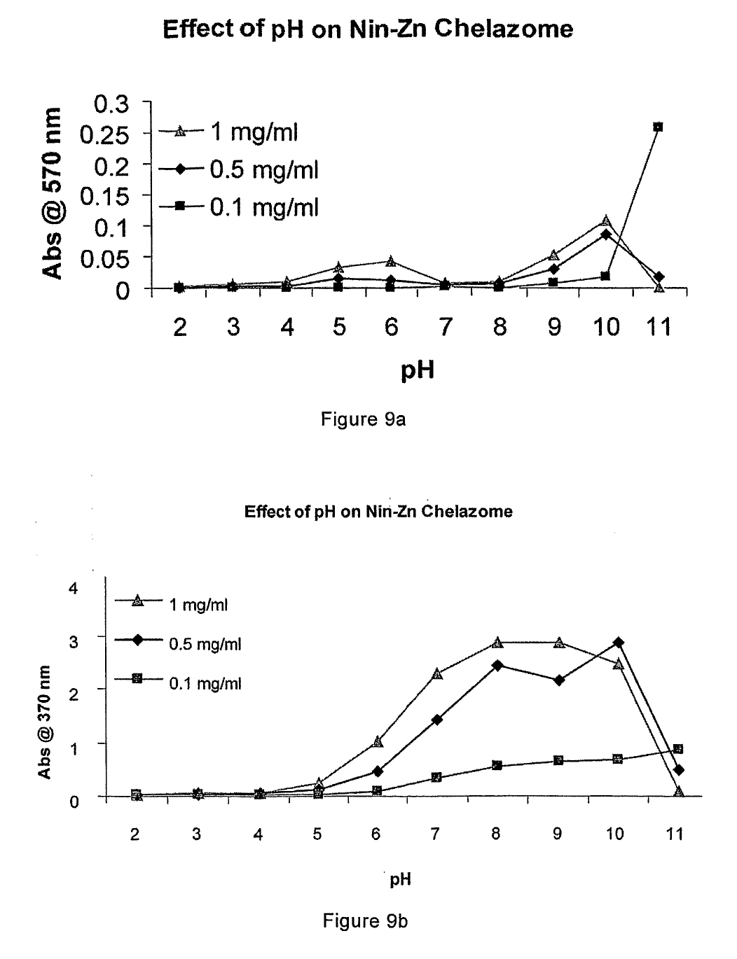

The effect of pH on the reaction of ninhydrin with Zn bisglycinate was determined using conditions used as before with some additional modifications. For these experiments, only the absorptions at 570 (FIG. 9a) and 370 nm (FIG. 9b) were measured and the solutions were allowed to react for 4 hours before measurements were made. Additionally, 0.1, 0.5 and 1.0 mg/mL concentrations of Zn bisglycinate were evaluated in an attempt to compensate for the low absorption at 570 nm. The results are shown in FIGS. 9a and 9b. From the plots in FIGS. 9a and 9b, it appears that at the two higher concentration experiments, there are two peaks associated with free glycine ligand at pH 5-6 and pH>10. There is a decrease in absorption at pH 11. At the lower concentration, there are not the two peaks associated with the 0.5 an 1.0 mg/mL test solutions, but there is an increase in absorbance at 570 nm at pH 11.

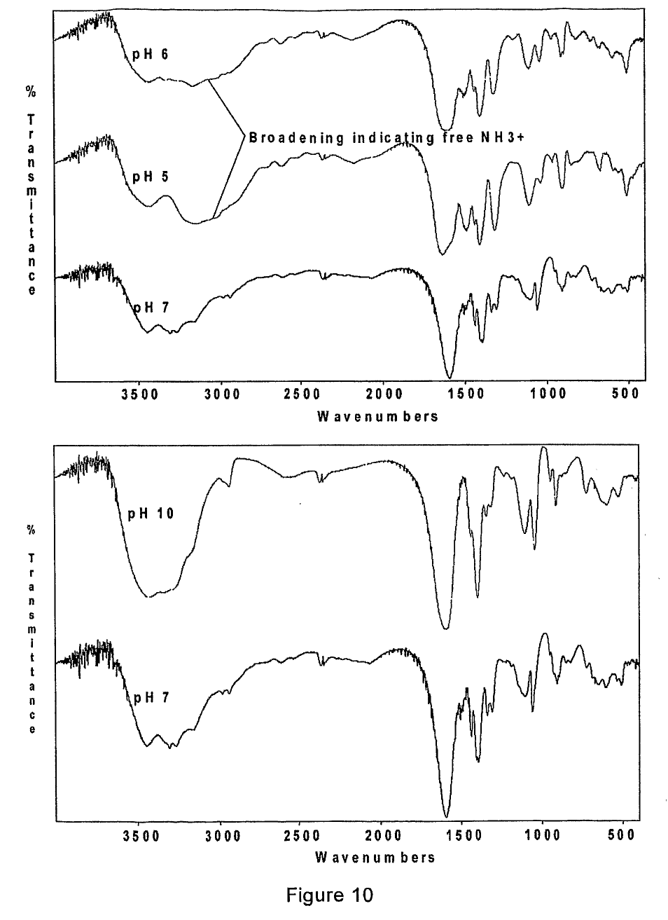

Since reaction of ninhydrin will result in Ruhemann's purple only in the presence of a free amine group, experiments were conducted to examine the effect of pH on the binding between the amine and the metal. Solutions of ZnBGly were pH adjusted to 5, 6, 7, and 10 using HCl or NaOH. The samples were then dried and FT-IR spectra were obtained. Using the peaks previously identified for chelation analysis (see U.S. patent application Ser. No. 10/245,826) the band assignments for both NH₃⁺ and NH₂ were examined. The product derived from the solution at pH 7 was established as the baseline reference for comparative purposes. The FT-IR spectra for ZnBGly dried from a solution of pH 5 and 6 compared to pH 7 is shown in FIG. 10. The pH 7 product is located as the bottom spectrum, the pH 5 product spectrum is above the pH 7 product spectrum (in the middle), and the pH 6 product spectrum above the pH 5 product spectrum (at the top). It is clear that there is a broadening of the peak at a frequency of 3000 cm⁻¹. The broader peak is indicative that there was some free amine for bonding with the ninhydrin. The comparison of FT-IR spectra for the ZnBGly product prepared at a pH of 7 and the product prepared at a pH of 10 is shown in FIG. 10. The ZnBGly product prepare at a pH of 10 product does not exhibit the same peak broadening in the 3000 cm⁻¹ region that the pH 5 and 6 products exhibited. However, it is clear that the peaks in this region are not as sharp and distinctive. This may be due to the OH group from the pH adjustment.

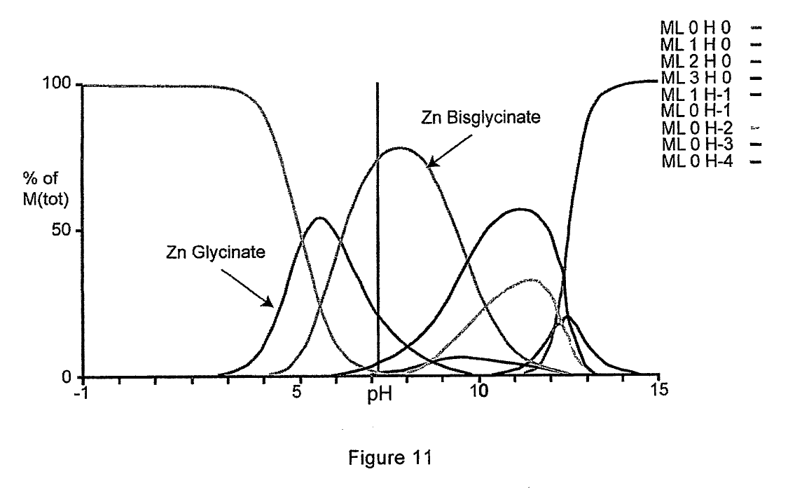

Speciation predictions were made for zinc and glycine across a broad pH range. Those predictions are displayed in FIG. 11. Zinc glycinate species formation was predicted over a pH range of from about 3 to about 10 in greatest abundance at a pH of between 5 and 6. Zinc bisglycinate formation was predicted over a pH range of from about 4 to about 12 in greatest abundance at a pH of between 7 and 8. The FT-IR data correlates with the speciation predictions for zinc(II) glycine. While not wishing to be bound to a particular theory, it is believed that the observed decrease in UV absorbance at pH 11 in the 0.5 and 1.0 mg/mL test solutions may be due to the formation of insoluble Zn glycine hydroxide complex rendering the glycine unavailable for reaction with ninhydrin. The increase in measured absorption at 570 nm in the 0.1 mg/mL sample at pH 11 is not fully explained by these speciation predictions. It may be due to different reaction dynamics at the lower concentration. When the pH ranged from about 2 to about 6, the amino nitrogen was likely not bound to zinc metal. This allowed the nitrogen to interact with ninhydrin forming Ruhemann's purple, while the carboxylic end of the amino acid remained ionically bound to zinc. In the case of the pH ranging from 8.5 to 11, hydroxides may associate with zinc and the amino acid dissociates from zinc allowing Ruhemann's purple to form.

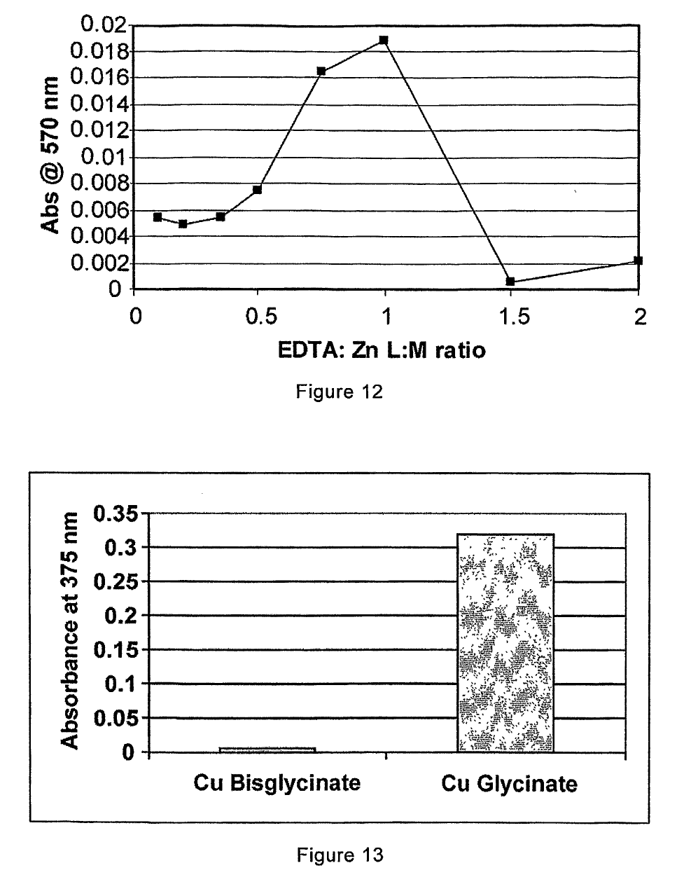

An additional experiment was conducted to examine the effect of competing ligands with the ninhydrin-Zn bisglycinate reaction with particular attention made with the absorption at 570 nm. A stock solution of 0.0306 M Na EDTA (ethylene di-amine tetra-acetic acid) was prepared. Solutions were prepared such that the molar ratio of Na EDTA to Zn from the zinc bisglycinate was varied. The ratios selected were 0.1, 0.2, 0.35, 0.5, 0.75, 1.0, 1.5, and 2.0. The zinc bisglycinate was pH adjusted to pH 7 prior to the addition of the Na EDTA. The solutions of Na EDTA and Zn bisglycinate were allowed to react together in the presence of ninhydrin for 4 hours at room temperature. The absorbance at 570 nm was measured after reaction for each sample. Results from these experiments are shown in FIG. 12. The absorbance at 570 nm was minimal and suggested that there was little formation of Zn EDTA complex with the resulting liberation of glycine. From a qualitative perspective, Ruhemann's purple was not observable at the end of the 4 hour period for each sample.

### Copper Bisglycinate Experimental Results

An HP 8453 spectrophotometer was used with a photodiode array (190 to 1100 nanometers) detector. The assay type was of simultaneous fixed wavelength with wavelengths of choice being 370, 405, and 570 nm using a background reference wavelength of 750 nanometers. Manual sampling was performed using a quartz cuvette with a path length of 1 cm.

When copper bisglycinate was initially tested for linear range finding purposes and to see if color correction would need to be performed, it was observed that ninhydrin copper bisglycinate resulted in a different λ max than the λ max for ninhydrin zinc bisglycinate. The ninhydrin copper bisglycinate reaction also produces a different visible color. Consequently, it may be expected that different λ max absorptions can be measured depending upon the kind of metal in the metal chelate. These λ max absorptions may be used for comparisons with ninhydrin amino acid reaction mixtures where the metal chelate is absent.

As shown in FIG. 13, experiments involving reaction of ninhydrin with copper bisglycinate and copper glycinate resulted in different absorption observations at 375 nm. The absence of absorbance for copper bisglycinate with the absorbance for copper glycinate is explained by the spatial configuration of each respective chelate. Copper bisglycinate exists in a planar configuration while copper glycinate exists in a tetrahedral configuration. The planar configuration of copper bisglycinate does not interact with ninhydrin.

### Stock Solution Preparation

A 1 liter solution of 1% (v/v) of DMSO in distilled water was prepared. This solution was used as the diluting solution for subsequent ninhydrin preparations. A 20 mg/mL stock solution of ninhydrin was prepared by weighing 1 g of spectrophotometric grade ninhydrin (Acros) and quantitatively transferring it to a 50 mL volumetric flask using 1% DMSO as the transfer liquid. The flask was filled to the neck with the 1% DMSO solution and placed in a sonication bath to dissolve the ninhydrin. This solution was allowed to cool for 30 minutes before adding the final amount of 1% DMSO and mixing by inverting. Ninhydrin is a light sensitive compound therefore, the solution needs to be stored in the dark or put in an amber glass container.

A 2 mg/mL zinc bisglycinate (Zinc Chelazome®, Albion Advanced Nutrition, Clearfield, Utah) stock solution was prepared by adding 200 mg of zinc bisglycinate to a 100 mL volumetric flask. Approximately 97% of the flask was filled with 1% DMSO solution and the flask was placed into a sonication bath to completely dissolve the zinc bisglycinate. The solution was removed from the sonication bath and allowed to cool for 30 minutes. The pH of the zinc bisglycinate solution was adjusted to 7.5±0.2 using 0.1 N HCl. The flask was then filled to final volume of 100 mL with 1% DMSO solution followed by further mixing.

A 2.5 mg/mL stock solution of glycine was mixed by adding 250 mg of high grade glycine (Sigma-Aldrich) to a 100 mL volumetric flask. The flask was filled to approximately 97% volume with 1% DMSO solution and placed into a sonication bath. When the glycine powder was visibly observed to have dissolved in solution, the flask was removed from the bath and cooled for 30 minutes. The pH of the glycine solution was adjusted to 7.5±0.2 using 0.1 N NaOH. The flask was then filled to a final volume of 100 mL with 1% DMSO solution followed by further mixing.

A 0.3 mg/mL (3%) stock solution of glycine control was prepared by adding 3 mg of high grade glycine (Sigma-Aldrich) to a 100 mL volumetric flask. 1% DMSO was added to the flask until it was approximately 97% full. The solution was sonicated, pH adjusted and diluted to final volume as previously described with the 2.5 mg/mL stock solution.

A 1 mg/mL zinc bisglycinate standard solution was prepared by adding 100 mg of zinc bisglycinate (the zinc bisglycinate was supplied by Albion Advanced Nutrition, Clearfield, Utah and subsequently recrystallized and vacuum filtered) to a 100 mL flask filled with approximately 97 mL of 1% DMSO solution. Before reaching the 100 mL mark, the pH of the solution was adjusted to 7.5 with 0.1 N HCl, and then filled to a final volume of 100 mL with 1% DMSO solution followed by further mixing.

A 0.5 mg/mL zinc bisglycinate check-control stock solution was prepared by adding 50 mg of zinc bisglycinate (the zinc bisglycinate was supplied by Albion Advanced Nutrition, Clearfield, Utah and subsequently recrystallized and vacuum filtered) to about 97 mL of 1% DMSO solution. The resulting mixture's pH was adjusted to 7.5 using 0.1 N HCl. The flask was then filled to a final volume of 100 mL with 1% DMSO solution.

A 0.5 mg/mL stock solution of a commercial zinc bisglycinate (Zinc Chelazome®, Albion Advanced Nutrition, Clearfield, Utah) was prepared by dissolving 50 mg of zinc bisglycinate into about 97 mL of 1% DMSO solution. The mixture's pH was adjusted to 7.5 with 0.1 N HCl, and then filled to a final volume of 100 mL with 1% DMSO solution.

### Glycine Standard Addition Procedures

Fifteen borosilicate test tubes (16×150 mm) were placed in a rack in two rows. One tube was labeled “blank” and contained a mixture of 1 mL of ninhydrin stock and 9 mL of 1% DMSO. In the first row of tubes, six tubes were labeled 0 to 5, and the last tube was labeled “addition stock”. Each tube was marked “sample.” The second row of seven tubes was labeled the same as the first row and marked “control”. Two mL of 1% DMSO were added to each of the test tubes marked 0 thru 5, and 4 mL were added to the tubes marked “addition stock”. In the first row of tubes marked “sample row”, 2 mL of the 2 mg/mL zinc bisglycinate stock (Zinc Chelazome®, Albion Advanced Nutrition, Clearfield, Utah) were added to each of the tubes labeled 0 thru 5 and 2 mL of glycine control stock was added to the second row of tubes marked 0 thru 5.

In the two remaining tubes labeled “addition stock”, 4 mL of the glycine stock solution were added. All solutions were mixed by vortex before adding any reagent. One mL of ninhydrin stock solution was added to each of the test tubes labeled 0 thru 5 for both rows. Two mL of ninhydrin stock solution were added to both test tubes labeled “addition stock”. All tubes were mixed by vortex again to ensure proper mixture. The color development of the mixtures were observed for a period of one hour. Alter 50 minutes, the “addition stock” tubes were transferred to a pre-heated hot water bath set at 50° C. for 5 minutes. Those addition stock tubes were transferred to an ice bath. All tubes were transferred to the same ice bath after the 1 hour time period. Using the appropriate “addition stock” tube, 1 mL was transferred to the tube labeled 1, 2 mL to the 2, 3 mL to the 3, and so on. The same procedure was done on the second row. All tubes labeled 0 to 5 on both rows were diluted to a final volume of 10 mL using 1% DMSO solution. All tubes were mixed by vortex and kept in an ice bath until samples were measured in a UV/Vis spectrophotometer.

### Direct Chelate Comparison Analysis Procedures

Three test tubes (16×150 mm) were labeled “standard”, “control”, and “sample”. Each tube received 2 mL of 1% DMSO solution. Two mL of the 1 mg/mL pure zinc bisglycinate stock solution was added to the tube labeled “standard”. Two mL of the 0.5 mg/mL check-control stock solution was added to the tube labeled “control”. Two mL of the 0.5 mg/mL zinc bisglycinate (Zinc Chelazome®, Albion Advanced Nutrition, Clearfield, Utah) stock solution was added to the tube labeled “sample”.

One mL of ninhydrin was added to each tube followed by vortex mixing. The mixtures were allowed to stand for 1 hour. Five mL of 1% DMSO solution was added to each of the tubes making the total volume 10 mL.

Five tubes labeled 1 through 5 received 2.5 mL of 1% DMSO solution. Using the “standard” tube as the high end of the curve, serial dilutions were made by drawing out 2.5 mL from the “standard” tube and transferring it to the tube labeled “5” followed by mixing with a pipette. Serial dilutions were made by transferring 2.5 mL from tube “5” to tube “4”, mixing and repeating the same from 4 to 3, etc. A blank was made by transferring 1 mL of the ninhydrin solution into a clean tube and then adding 9 mL of 1% DMSO solution. All tubes were placed in an ice bath to stabilize the solutions until samples from all the solutions had been measured in a spectrophotometer. All solutions were measured by UV/Vis spectrophotometer monitoring three fixed wavelengths 370, 405, and 570 nm, utilizing 750 nm as a baseline value.

### Concentration Study

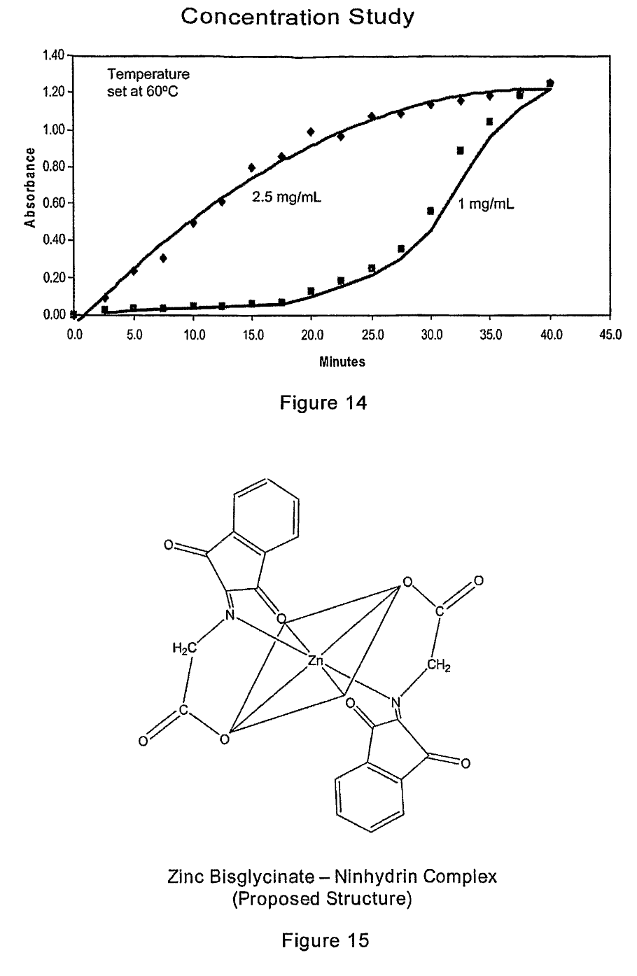

Data points of absorption at 370 nm for two concentration values, 1 mg/mL and 2.5 mg/mL, were plotted at increasing time of reaction intervals as displayed in FIG. 14 when experiments were conducted at a temperature of 60° C. The concentration of ninhydrin in the solution was found to affect the reaction kinetics in several ways. First, it affected the completion time by increasing or decreasing the time for the reagents to fully react. Second, it changed the curve linearity by altering the curve exponentially or second order. Lastly, it darkened the color of the solutions when the end reaction was complete. The absorption at 370 nm was found to be more intense than the absorption at 570 nm. In effect, if a small 570 nm band formed during the reaction, the corresponding 370 in peak would be overwhelming and exceeds the absorption scale of the instrument. These results indicate that color development works best when the ninhydrin reagent is added to a high concentrated solution. Once color has developed, a final dilution can be made to bring the chromophore adduct solution into the observable scale of the instrument.

The timing of the reaction is critical because of the stability of the chelate-ninhydrin complex. Experimental results indicate that if the solutions were concentrated, and time was extended beyond what was needed to complete the reaction, the color can change enough to compromise the assay. It was also noted that the yellow-colored solution (370 nm) developed more rapidly than solutions which produced Ruhemann's purple solution. Experimental results show that 1 hour is the optimum time required to develop the yellow (370 nm) color indication using a stronger concentration and low temperature parameters; whereas, with the same conditions, the purple (570 nm) color would take approximately 4 hours for complete color development. Changing the concentration or raising the temperature shortens the time required for development but can produce inconsistent results when looking for both colors simultaneously.

### Qualitative and Quantitative Assays

A simple way to assay for metal chelates would be a direct colorimetric assay using a pure chelate sample to generate a standard addition curve. Two different approaches to generating a standard addition curve were examined. First, a standard addition curve using a known chelate can be generated. For this approach, the example of a zinc bisglycinate direct calorimetric assay with a pure zinc bisglycinate standard was performed. Second, a standard addition curve observing the amount of free ligand can be generated. For this approach, the example of assaying for free glycine in a zinc bisglycinate system was performed. A second experiment generating a standard addition curve for glycine ninhydrin adducts was performed.

Because there is no commercial source for a laboratory standard of zinc bisglycinate, a pure standard was synthesized and purified by repeated filtering and recrystallization over a period of 4 months. ICP mass spectrum and elemental analysis (LECO elemental analyzer) assays of zinc, carbon, and nitrogen were done so the percent ratio could be calculated. The synthesized zinc bisglycinate was calculated as being 99±1% percent pure. Structural data obtained by FT-IR showed all of the functional groups of the zinc bisglycinate present, and a mass spectrum was obtained to further confirm the structure's molecular weight.

Stock solutions used in the quantitative zinc bisglycinate assays were prepared according to the data in Table 1.

TABLE 1
Stock Solutions

| | mg | mL | mg/mL |
|---|---|---|---|
| Standard Stock | 97.82 | 100 | 0.9782 |
| Control Stock | 67.70 | 100 | 0.6770 |
| Chelazome ® Stock | 57.74 | 100 | 0.5774 |

All solutions being tested for concentration of chelate were mixed at 0.5 mg/mL except for the standard zinc bisglycinate solution where it was mixed at 1 mg/mL concentration. Reaction temperatures were held constant at room temperature (25° C.), and the pH was adjusted to 7.5. Ninhydrin (in excess) solution was added to the solutions and allowed to react for 1 hour. All solutions were placed in an ice bath to stabilize the color prior to obtaining spectral measurements. Spectral data was measured at 370 nm (yellow color) absorbance using UV/Vis spectrophotometer with a photodiode array detector. Absorbance measurements were recorded for each zinc bisglycinate sample also displayed in Table 2.

TABLE 2

| Zinc Bisglycinate Standard | |
|---|---|
| Concentration (mg/mL) | UV/Vis Absorbance |
| 0.024455 | 0.0586 |
| 0.04891 | 0.4593 |
| 0.09782 | 1.2733 |
| 0.19564 | 2.5007 |

Results of the direct calorimetric assay using pure zinc bisglycinate yielded a value around 98±0.5% zinc bisglycinate. The zinc bisglycinate standard curve fits with an R² value of 0.9946. A comparison of the zinc bisglycinate and control experiments is displayed in Table 3.

TABLE 3

| | | | | Calculated |
|---|---|---|---|---|
| | | | | Zinc |
| | UV/Vis | Calculated | Calculated | Bisglycinate |
| | Absorbance | mg/mL | mass in grams | Percentage |
| Control | 1.6983 | 0.135754 | 0.06787686 | 100.3% |
| Zinc | 1.3765 | 0.113086 | 0.05654317 | 97.9% |
| Chelazome ® | | | | |

Another approach to assaying a metal chelate such as Albion's Zinc Chelazome® product would be to calculate free glycine or unbound nitrogen in glycine. In theory, any unbound nitrogen would be available for ninhydrin interaction and should form Ruhemann's purple (570 nm). Because the 370 nm absorption (yellow color) complex is a stronger, more intensely absorbing chromophore-adduct than the Ruhemann's purple, the problems associated with concentrations and temperature as well as the low amount of glycine in the sample can present problems. The amount of glycine might fall below the detection limit for an instrument. Therefore, standard additions can result in more accurate experiments. One technique for avoiding competing concentration related problems is to react a known concentration of ninhydrin with 1) a 2.5 mg/mL solution of glycine and 2) a 3% glycine solution in separate vessels. Then add the resulting ninhydrin-glycine adduct solution (“purple solution” from the 2.5 mg/mL solution of glycine) in different aliquots to the 3% glycine solutions in separate tubes to construct a standard addition curve. After the solutions are measured by UV/Vis spectrometer at 570 nm, the measurements are calculated by graphing a linear line and extrapolating a value from the curve. The glycine in solution is calculated by making the absorbance value equal to zero.

A trial experiment using a 3% solution of glycine was performed using a standard addition technique with an experimental result of 2.97% glycine. A sample stock solution was prepared by mixing 211.7 mg of zinc bisglycinate in 100 mL of 1% DMSO in distilled water to yield a 2.117 mg/mL solution. Samples of zinc bisglycinate were prepared as shown in Table 4. 1 mL of excess ninhydrin was added to each sample and reacted for a period of 1 hour at 25° C. This novel standard addition approach was used to evaluate the unbound glycine in an Albion Zinc Chelazome® sample. A sample stock solution of zinc bisglycinate was prepare using 211.7 mg of the chelate in a 100 mL solution of 1% DMSO in distilled water with a 2.117 mg/mL chelate solution. Samples of various concentrations were prepared from this solution as listed in Table 4. 1 mL of excess ninhydrin was added to each sample and allowed to react at 25° C. for a period of 1 hour after which UV measurements were obtained as listed in Table 4.

TABLE 4

| Chelazome ® Concentration | |
|---|---|
| (mg/mL) | UV/Vis Absorbance |
| 0 | 0.0128 |
| 0.05026 | 0.0571 |
| 0.10052 | 0.1013 |
| 0.15078 | 0.1475 |
| 0.20104 | 0.1944 |
| 0.2513 | 0.2454 |
| 0.5026 | 0.4291 |

The concentration of unchelated glycine in the chelate solution was calculated to be 0.05762 mg/mL or 0.00576 g or 2.72% free glycine in the chelate. The data was fit to a R² value of 0.9997.

Quantitative measurements of glycine stock solutions were made for control and reference purposes. 3.11 mg of glycine were added to a 100 mL solution of 1% DMSO in distilled water yielding a glycine concentration of 0.311 mg/mL. Incremental concentrations of glycine samples were prepared and then reacted with 1 mL of excess ninhydrin for a period of 1 hour at 25° C. Each sample was then examined with a UV spectrometer. The absorbance and concentration for each respective glycine sample is displayed in Table 5.

TABLE 5

| Glycine Concentration | |
|---|---|
| (mg/mL) | UV/Vis Absorbance |
| 0 | 0.0086 |
| 0.05008 | 0.2938 |
| 0.10016 | 0.5807 |
| 0.15024 | 0.8603 |
| 0.20032 | 1.1430 |
| 0.2504 | 1.4266 |
| 0.5008 | 2.7384 |

The concentration of glycine in stock solution was observed and calculated to be 0.00925 mg/mL or 0.00092 g or 2.97% glycine in solution using the relationship y=mx+b. The R² value was calculated to be 1.

Ninhydrin's reaction at room temperature with zinc bisglycinate chelate produced a ninhydrin-zinc bisglycinate complex with spectral data distinctively different from that of Ruhemann's purple. The absorption maximum for this complex is at 370 nm and forms a yellow color. The formation of this complex is believed to be a result of a coordinate-covalent bond between nitrogen and zinc which ties up the ninhydrin in a complex, shutting down the typical ninhydrin-amino acid reaction path depicted in Scheme 3. However, when the chelate bond between the amino acid and metal is not present, ninhydrin will undergo normal interaction with the amino acid forming Ruhemann's purple (Scheme 2). This was confirmed by reacting sodium glycinate with ninhydrin. The development of Ruhemann's purple when ninhydrin is mixed with the sodium glycinate further evidences the reaction pathways. Some manipulations of temperature were performed on the ninhydrin-glycine addition solution. We found that if the solution used for the standard addition was heated to 50° C. for 5 minutes prior to the completion of the sample solution, the end values were more consistent.

Other environmental parameters that needed to be controlled for the optimal formation of the chelate-chromophore adduct (yellow color at 370 nm) were pH, time of reaction and concentration of reactants. It was found that the optimal pH range was 6.5-8.5, and that the optimal time for the reaction at room temperature was 1 hour. Kinetics of the reaction were dependent on the concentration of the reactants, but there was some latitude for adjustment depending on the experimental needs.

It was considered that the yellow complex was a result of interference caused by mixing zinc with ninhydrin. Controls used during the experiments mixing zinc salts (zinc citrate, zinc chloride) with ninhydrin showed no evidence of color development.

Although the structure of the ninhydrin-zinc bisglycinate complex has not been precisely determined, it is contemplated that a complex structure similar to a zinc bisglycinate-ninhydrin complex exists (FIG. 15).

The synthesis of a 99% pure zinc bisglycinate standard helped in the development of a method using ninhydrin to analyze for zinc bisglycinate purity.

A second technique using ninhydrin to analyze for residual glycine was developed by a standard addition method by reacting ninhydrin with glycine and adding it to several zinc bisglycinate solutions in a series of dilutions.

In another series of experiments, a drop plate was prepared with a number of wells. To each well was added 5 to 10 mg of an analyte. To each well was added 5 drops of a 20 mg/mL solution of ninhydrin. The observed results of the experiment are shown in Table 6.

TABLE 6

| Analyte | Observed Indication |
|---|---|
| zinc bisglycinate | yellow |
| copper lysinate | transiently yellow, then |
| | purple |
| copper bislysinate | purple |
| Ferrochel ® Ferrous | yellow |
| bisglycinate (Albion | |
| Advanced Nutrition, | |
| Clearfield, Utah) | |
| calcium bisglycinate | yellow |
| magnesium bisglycinate | yellow |
| glycine | purple |
| boron bisglycinate | initially clear, then yellow, |
| | (later slight purple at the |
| | margin of the analyte) |

In another experiment, a drop plate was prepared with a well containing zinc 5 to 10 mg of bisglycinate. A few drops of 0.1 molar sodium hydroxide solution were added to the well. Following addition of the caustic solution, 5 drops of 20 mg/mL ninhydrin solution were added. The resulting product was observed to produce a yellow color.

### Compounds

Compounds of the invention include those of Formula 20 (Mₐ)^{e+}(Lum)_{b}(L)_{c}(H₂O)_{d} where M is a metal, Lum is a luminophore, L is any suitable ligand capable of binding to a metal, a is 1 or 2, b is 1, 2, 3, or 4, c is 1, 2, 3, or 4, d is 0, 1, 2, 3, 4, 5, 6, 7, or 8, and e is 0, 1, 2, 3, 4, 5, 6, 7, or 8. Preferred compounds are those of Formula 20 where M is selected from the alkaline, alkaline earth, and transition metals, a is 1, e is 0, 1, 2, 3, 4, 5, 6, 7, or 8, Lum is selected from Formulas 2-13 and Y is O, b is 2, L is an amino acid, c is 2 and d is 0, 1, 2, 3, 4, 5, 6, 7, or 8. More preferred compounds are those of Formula 20 where M is selected from calcium, chromium, copper, iron, magnesium, manganese, molybdenum, potassium, selenium, vanadium and zinc, a is 1, e is 1, 2, 3, or 4, Lum is selected from ninhydrin, benzo[f]ninhydrin, benzo[f]furoninhydrin, 5-(4-nitrophenyl)ninhydrin, 5-methoxy-ninhydrin, 5-(methylthio)ninhydrin, thieno[f]ninhydrin, 5-(2-thienyl)ninhydrin, 5-(3-thienyl)ninhydrin, 1,8-diazaflourenone, and ninhydrin d is 0, 1, 2, 3, 4, 5, 6, 7, or 8. Even more preferred compounds are those of Formula 20 where M is selected from copper, iron, manganese, and zinc, a is 1, e is 1, 2, 3, or 4, Lum is selected from substituted and unsubstituted ninhydrin, d is 0, 1, 2, 3, 4, 5, 6, 7, or 8. Still more preferred compounds are those of Formula 20 where M is selected from copper, iron, manganese, and zinc, a is 1, e is 1, 2, 3, or 4, Lum is ninhydrin, d is 0, 1, 2, 3, 4, 5, 6, 7, or 8. It is contemplated that Lum may be substituted with Chr where Chr represents a chromophore.

Illustrative examples of the foregoing include Compound 1, where M is Cu (copper), a is 1, e is 1, Lum is ninhydrin, b is 1, L is glycine, c is 1, and d is 0 and Compound 2, where M is Cu, a is 1, e is 2, Lum is ninhydrin, b is 2, L is glycine, c is 2, and d is 0. Additional examples of chelates with ninhydrin and copper include Compound 3, where M is Cu (copper), a is 1, e is 1, Lum is ninhydrin, b is 1, L is lysine, c is 1, and d is 0 and Compound 4, where M is Cu, a is 1, e is 2, Lum is ninhydrin, b is 2, L is lysine, c is 2, and d is 0. Additional examples of chelates with ninhydrin and copper include Compound 5, where M is Cu (copper), a is 1, e is 1, Lum is ninhydrin, b is 1, L is tyrosine, c is 1, and d is 0 and Compound 6, where M is Cu, a is 1, e is 2, Lum is ninhydrin, b is 2, L is tyrosine, c is 2, and d is 0. The aforementioned chelates may be optionally hydrated such as the monohydrate of compounds 1-6, the dihydrate f compounds 1-6, the trihydrate of compounds 1-6, the tetrahydrate of compounds 1-6, the pentahydrate of compounds 1-6, the hexahydrate of compounds 1-6, the heptahydrate of compounds 1-6, and the octahydrate of compounds 1-6.

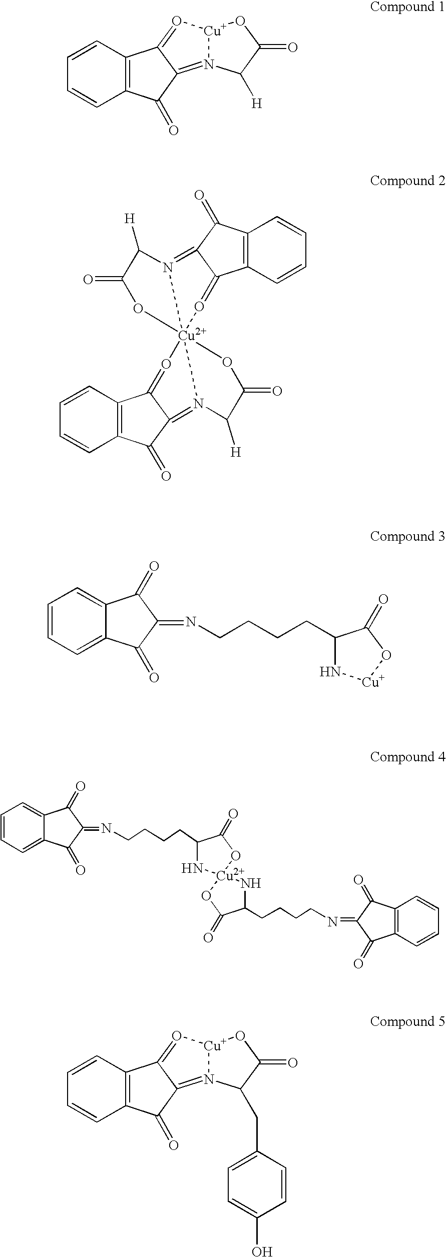

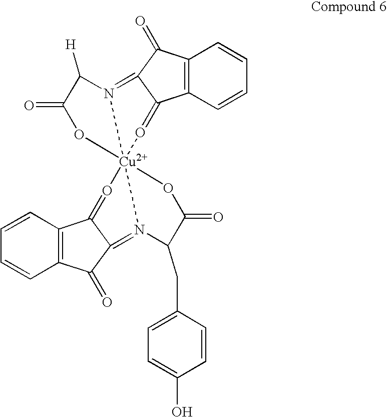

Additional examples of chelates include those where the metal is iron (M=Fe) such as Compound 7, where a is 1, e is 2, Lum is ninhydrin, b is 1, L is glycine, c is 1, and d is 0 and Compound 8, where a is 1, e is 3, Lum is ninhydrin, b is 2, L is glycine, c is 2, and d is 0. Additional examples of chelates with ninhydrin and iron include Compound 9, where a is 1, e is 2, Lum is ninhydrin, b is 1, L is lysine, c is 1, and d is 0 and Compound 10, where a is 1, e is 3, Lum is ninhydrin, b is 2, L is lysine, c is 2, and d is 0. Additional examples of chelates with ninhydrin and iron include Compound 11, where a is 1, e is 2, Lum is ninhydrin, b is 1, L is tyrosine, c is 1, and d is 0; Compound 12, where a is 1, e is 3, Lum is ninhydrin, b is 2, L is tyrosine, c is 2, and d is 0. The aforementioned chelates may be optionally hydrated such as the monohydrate of compounds 7-12, the dihydrate f compounds 7-12, the trihydrate of compounds 7-12, the tetrahydrate of compounds 7-12, the pentahydrate of compounds 7-12, the hexahydrate of compounds 7-12, the heptahydrate of compounds 7-12, and the octahydrate of compounds 7-12.

Additional examples of chelates include those where the metal is manganese (M=Mn) such as Compound 13 where a is 1, e is 2, Lum is ninhydrin, b is 1, L is glycine, c is 1, and d is 0, Compound 14, where a is 1, e is 2, Lum is ninhydrin, b is 1, L is lysine, c is 1, and d is 0, Compound 15, where a is 1, e is 2, Lum is ninhydrin, b is 1, L is tyrosine, c is 1, and d is 0. The aforementioned chelates may be optionally hydrated such as the monohydrate of compounds 13-15, the dihydrate f compounds 13-15, the trihydrate of compounds 13-15, the tetrahydrate of compounds 13-15, the pentahydrate of compounds 13-15, the hexahydrate of compounds 13-15, the heptahydrate of compounds 13-15, and the octahydrate of compounds 13-15.

Additional examples of chelates include those where the metal is zinc (M=Zn) such as Compound 16 where a is 1, e is 2, Lum is ninhydrin, b is 1, L is glycine, c is 1, and d is 0, Compound 17, where a is 1, e is 2, Lum is ninhydrin, b is 1, L is lysine, c is 1, and d is 0, Compound 18, where a is 1, e is 2, Lum is ninhydrin, b is 1, L is tyrosine, c is 1, and d is 0. The aforementioned chelates may be optionally hydrated such as the monohydrate of compounds 16-18, the dihydrate f compounds 16-18, the trihydrate of compounds 16-18, the tetrahydrate of compounds 16-18, the pentahydrate of compounds 16-18, the hexahydrate of compounds 16-18, the heptahydrate of compounds 16-18, and the octahydrate of compounds 16-18.

Methods of Preparing Chelated Metals

Compounds of the invention are prepared by the method depicted in Scheme 5. Chromophores of Formula 3 where Y can be O, S, or Se, preferably O, and Z is any conjugated π system, preferably an aromatic conjugated π system, is mixed with a single ligand chelate of Formula 14 where M is a metal, preferably a transition state metal, and R₆ is any organic substituent, preferably those organic substituents that are side chains from amino acids and more preferably those side chains from the naturally occurring amino acids, to obtain a compound of Formula 15. The method depicted in Scheme 1 also includes reacting chromophores of Formula 3 with a double ligand chelate of Formula 16 to obtain a compound of Formula 17. It is contemplated that single ligand chelates of Formula 14 and double ligand chelates of Formula 16 could also be peptides; consequently, chromophore ligand adducts chelated to a metal in Formulas 15 and 17 would also include ligands that are peptides. Further, Formulas 14 and 16 represent single and double amino acid chelates but could also include other forms of chelates including polyligated chelates of two or more ligands with corresponding polyligated chelates similar to those of Formulas 15 and 17.

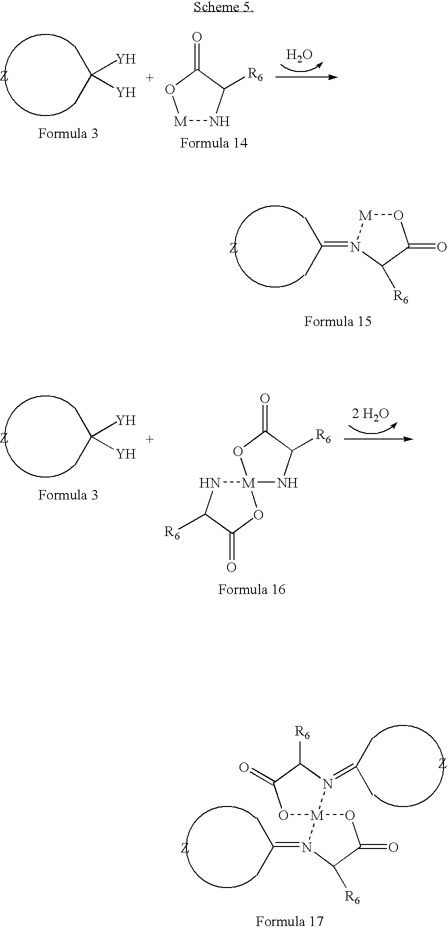

In similar fashion, compounds of Formulas 5, 7, 9, 11, and 13 can react with compounds of Formulas 14 and 16 or polyligated chelates to obtain corresponding chromophore ligand adducts chelated to a metal. In the reactions contemplated by the invention, water can a byproduct and can be incorporated in the compositions in the form of a hydrate such as a monohydrate, a dehydrate, a octahydrate and the like.

In particular embodiments, the chromophore ninhydrin is used to prepare compounds of the invention as depicted in Scheme 6. Single ligand chelates of Formula 14 react with ninhydrin to obtain chelates of Formula 18. Double ligand chelates of Formula 16 react with ninhydrin to obtain chelates of Formula 19.

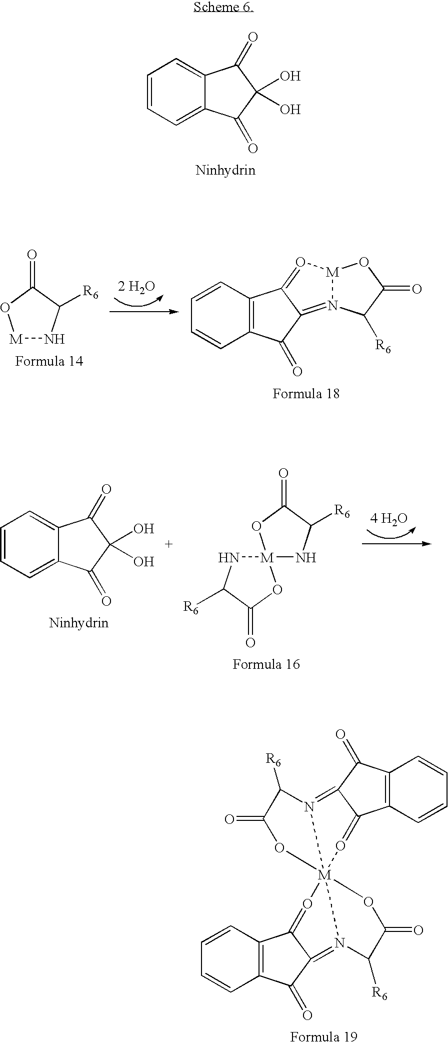

We claim:

1. A method of assaying for the presence or absence of a metal-ligand chelate in a sample, wherein the sample contains either a metal-ligand chelate or a free ligand, comprising:
a. reacting the sample with a luminophore to obtain a reaction product, wherein the reaction of the luminophore with a sample containing a metal-ligand chelate produces a metal-ligand-luminophore chelate and the reaction of the luminophore with a sample containing free ligand produces a ligand-luminophore adduct;
b. detecting the electromagnetic spectrum of the reaction product;
c. matching the electromagnetic spectrum of the reaction product with an electromagnetic spectrum metal-ligand chelate luminophore chelate, or matching the electromagnetic spectrum of the reaction product with an electromagnetic spectrum of a ligand-luminophore adduct;
d. correlating a match of the electromagnetic spectrum of the reaction product and the electromagnetic spectrum of the metal-ligand-luminophore chelate with the presence of a metal-ligand chelate, or correlating a match of the electromagnetic spectrum of the reaction product and the electromagnetic spectrum of the ligand-luminophore adduct with the absence of a metal-ligand chelate.

2. The method of claim 1, wherein electromagnetic spectra are in the ultraviolet region or the visible region or both.

3. The method of claim 1, wherein the first and second electromagnetic spectra are in the infrared region.

4. The method of claim 1, wherein the ligand is an amino acid.

5. The method of claim 1, wherein the mineral is selected from group consisting of: boron, calcium, chromium, cobalt, copper, iron, magnesium, manganese, molybdenum, potassium, selenium, vanadium, and zinc.

6. The method of claim 1, wherein the luminophore is ninhydrin.

7. A method of qualitatively assaying for the presence or absence of a metal-ligand chelate in a sample, comprising:
(a) adding to the sample a luminophore capable of reacting with one or more of:
(i) a metal-ligand chelate, to produce an electromagnetic signature characteristic of a metal-ligand-luminophore adduct, and
(ii) a free ligand, to produce an electromagnetic signature characteristic of a ligand-luminophore adduct;
(b) detecting the electromagnetic signature of on or more of the metal-ligand-luminophore adduct and the ligand-luminophore adduct;
(c) correlating the electromagnetic signature detected in step (b) with the presence or absence of the metal-ligand chelate.

8. A method of qualitatively assaying for the presence or absence of a metal-ligand chelate in a sample, comprising:
(a) adding to the sample a chromophore capable of reacting with one or more of:
(i) a metal-ligand chelate, to produce an electromagnetic signature characteristic of a metal-ligand-luminophore adduct, and
(ii) a free ligand, to produce an electromagnetic signature characteristic of a ligand-luminophore adduct;
wherein the mineral is selected from the group consisting of: group consisting of: boron, calcium, chromium, cobalt, copper, iron, magnesium, manganese, molybdenum, potassium, selenium, vanadium, and zinc, and the ligand is selected from the group consisting of: alanine, glycine, histidine, isoleucine, leucine, methionine, phenylalanine, serine, tryptophan, and valine;
b. detecting the electromagnetic signature of one or more of the metal-ligand-luminophore adduct and the ligand-luminophore adduct wherein the luminophore is selected from the group consisting of: ninhydrin, benzo[f]ninhydrin, benzo[f]furoninhydrin, 5-methoxy-ninhydrin, 5-(methylthio)ninhydrin, thieno[f]ninhydrin, 5-phenyl-thienylninhydrin, 5-thienylninhidrin, 5-(2-thienyl)ninhydrin, and 5-(3-thienyl)ninhydrin;
c. correlating the electromagnetic signature detected in step (b) with the presence or absence of the metal-ligand chelate.

9. The method according to claim 7, wherein the luminophore is selected from a chromophore and a fluorophore.

10. The method according to any of claims 7 and 9, wherein the luminophore is selected from the group consisting of: ninhydrin, benzo[f]ninhydrin, benzo[f]furoninhydrin, 5-methoxy-ninhydrin, 5-(methylthio)ninhydrin, thieno[f]ninhydrin, 5-phenyl-thienylninhydrin, 5-thienylninhidrin, 5-(2-thienyl)ninhydrin, 5-(3-thienyl)ninhydrin, and benzoflavanone.

11. The method according to claim 10, wherein the luminophore is ninhydrin.

12. The method according to claim 9, wherein the fluorophore is 1,8-diazaflourenone.

13. The method according to claim 7, wherein the mineral of the metal-ligand chelate is selected from the group consisting of: alkaline, alkaline earth, transition metalloids and rare earth metals.

14. The method according to claim 13, wherein the mineral of the metal-ligand chelate is selected from the group consisting of the nutritionally relevant minerals.

15. The method according to claim 14, wherein the mineral of the metal-ligand chelate is selected from the group consisting of: group consisting of: boron, calcium, chromium, cobalt, copper, iron, magnesium, manganese, molybdenum, potassium, selenium, vanadium, and zinc.

16. The method according to claim 13, wherein the mineral of the metal-ligand chelate is selected from the group consisting of magnesium, calcium, copper, zinc, iron, chromium, cobalt, molybdenum, selenium and manganese.

17. The method according to claim 7, wherein the ligand is one or more of monodentate, bidentate, tridentate and tetradentate ligands.

18. The method according to claim 17, wherein the ligand is one or more of the α-amino acids.

19. The method according to claim 17, wherein the ligand is a carboxylic acid optionally substituted with one or more heteroatoms.

20. The method according to claim 19, wherein at least one ligand is an amino acid and another ligand is selected from the group consisting of: citric acid, ascorbic acid, acetic acid, lactic acid, malic acid, succinic acid, and combinations thereof.

21. The method according to claim 17, wherein the ligand is a carbohydrate.

22. The method according to claim 21, wherein the ligand is selected from the group consisting of: glucose, sucrose, glucosamine, and combinations thereof.

23. The method according to claim 18, wherein the ligand is one or more of alanine, glycine, histidine, isoleucine, leucine, methionine, phenylalanine, serine, tryptophan, and valine.

24. The method according to any of claims 8 and 23, wherein the ligand is one or more of alanine, glycine, isoleucine, leucine, and valine.

25. The method according to claim 7, wherein the ligand is one or more of 4-hydroxyproline, 5-hydroxylysine, homoserine, homocysteine, ornithine, β-alanine, γ-aminobutyric acid, statine, ornithine, and statin.

26. The method according to claim 7, wherein the ligand is one or more peptides.

27. The method according to claim 7, wherein the ligand is selected from one or more cryptands.

28. The method according to claim 27, wherein the ligand is a cyclic peptide.

29. The method according to claim 7, wherein the metal-ligand chelate is a metal proteinate.

30. The method according to claim 7, wherein electromagnetic signature is selected from an absorption spectrum and an emission spectrum.

31. The method according to claim 7, wherein electromagnetic signature is in one or more of the ultraviolet range, the infrared range, and the visible range.

32. The method according to claim 7, wherein the luminophore is capable of reacting with both the metal-ligand chelate and a free ligand.

33. The method according to claim 7, wherein the luminophore is capable of reacting with only the free ligand.

34. The method according to claim 7, further comprising the step of quantitating the amount of the analyte present in the sample.

35. A method of quantitatively assaying for the amount of a metal-ligand chelate in a sample, the method comprising:
(a) adding to the sample a luminophore capable of reacting with one or more of:
(i) a metal-ligand to produce an electromagnetic signature characteristic of a metal-ligand-luminophore adduct electromagnetic absorbance;
(ii) a free ligand to produce a luminophore-adduct electromagnetic absorbance;
(b) detecting the sample electromagnetic absorbance;
(c) correlating the electromagnetic absorbance of the sample with the amount of a metal-ligand chelate present in the sample using a reference standard of the metal-ligand-luminophore adduct at various concentrations.

36. The method according to claim 35, wherein correlating the sample electromagnetic signature with the amount of a metal-ligand chelate is accomplished by determining the amount of a metal-ligand chelate from at least one of the metal-ligand-luminophore adduct electromagnetic absorbance and the ligand-luminophore adduct electromagnetic absorbance using Beers law.

37. The method according to claim 35, wherein correlating the sample electromagnetic signature with the amount of a metal-ligand chelate is accomplished by determining the amount of a metal-ligand chelate from at least one of the metal-ligand-luminophore-adduct electromagnetic absorbance and the ligand-luminophore adduct electromagnetic absorbance using standard addition.

38. The method according to claim 37, wherein a known amount of the metal-ligand chelate is added to the sample.

39. The method according to claim 37, wherein a known amount of the free ligand is added to the sample.

40. The method according to claim 37, wherein a known amount of the metal-ligand-luminophore adduct to the sample.

41. The method according to claim 37, wherein a known amount of the ligand-luminophore adduct to the sample.

42. A method for determining whether a ligand binds to a metal, comprising:
(a) contacting the a sample with a luminophore capable of forming a ligand-luminophore adduct having a characteristic electromagnetic signature;
(b) obtaining an electromagnetic signature of the sample contacted with the luminophore;
(c) correlating the electromagnetic signature of the sample with the electromagnetic signature of the ligand-luminophore adduct to thereby determine whether the test ligand binds to the metal.

43. The method according to claim 42, wherein the electromagnetic signature of the sample with a luminophore provides a visual indication of chelation.

44. The method according to claim 42, wherein the chromophore is selected from the group consisting of: ninhydrin, benzo[f]ninhydrin, benzo[f]furoninhydrin, 5-methoxy-ninhydrin, 5-(methylthio)ninhydrin, thieno[f]ninhydrin, 5-phenyl-thienylninhydrin, 5-thienylninhidrin, 5-(2-thienyl)ninhydrin, 5-(3-thienyl)ninhydrin, and benzoflavanone.

45. The method according to claim 42, wherein the chromophore is ninhydrin.

46. The method according to claim 42, wherein the metal is selected from the group consisting of the nutritionally relevant minerals.

47. The method according to claim 46, wherein the metal is selected from the group consisting of: boron, calcium, chromium, cobalt, copper, iron, magnesium, manganese, molybdenum, potassium, selenium, vanadium, and zinc.

48. The method according to claim 42, further comprising determining the molar absorptivity of the metal-ligand-luminophore adduct.

49. The method according to claim 42, further comprising determining the molar absorptivity of the ligand-luminophore adduct.

50. A compound of the formula (Mₐ)^{e+}(Lum)_{b}(L)_{c}(H₂O)_{d} wherein:
M is a metal;
Lum is a luminophore;
L is any suitable ligand capable of binding to a metal;
a is 1 or 2;
b is 1, 2, 3, or 4;
c is 1, 2, 3, or 4;
d is 0, 1, 2, 3, 4, 5, 6, 7, or 8; and,
e is 0, 1, 2, 3, 4, 5, 6, 7, or 8.

51. A compound of formula (Mₐ)^{e+}(Lum)_{b}(L)_{c}(H₂O)_{d} wherein:
M is a transition metal;
Lum is a substituted ninhydrin;
L is an amino acid;
a is 1;
b is 1 or 2;
c is 1 or 2;
d is 0, 1, 2, 3, 4, 5, 6, 7, or 8; and,
e is 0, 1, 2, 3, 4, 5, 6, 7, or 8.

52. A compound of formula (Mₐ)^{e+}(Lum)_{b}(L)_{c}(H₂O)_{d} wherein:
M is a transition metal selected from the group comprising: zinc, iron, copper, and manganese;
Lum is a luminophore selected from the group comprising: ninhydrin, benzo[f]ninhydrin, benzo[f]furoninhydrin, 5-(4-nitrophenyl)ninhydrin, 5-methoxy-ninhydrin, 5-(methylthio)ninhydrin, thieno[f]ninhydrin, 5-(2-thienyl)ninhydrin, 5-(3-thienyl)ninhydrin, 1,8-diazaflourenone, ninhydrin, and benzoflavanone.
L is a naturally occurring amino acid selected from the group comprising: aliphatic, aromatic, acidic, basic, hydroxylic, sulphur-containing, and amidic amino acids;
a is 1;
b is 1 or 2;
c is 1 or 2;
d is 0, 1, 2, 3, 4, 5, 6, 7, or 8; and,
e is 1, 2, 3, 4, 5, 6, 7, or 8.

53. A compound made from the reaction of a metal chelate and a luminophore wherein the metal chelate is of the formula (Mₐ)^{e+}(L)_{c}, where M is a metal, L is a ligand, a is 1 or 2, c is 1, 2, 3, or 4, e is 1, 2, 3, 4, 5, 6, 7, or 8, the luminophore comprising a carbonyl conjugated to a pi-system with an electromagnetic absorption pattern in the range of about 100 μm to 10 nm.

54. A compound made from the reaction of a metal chelate and a luminophore wherein the metal chelate is of the formula (Mₐ)^{e+}(L)_{c}, where M is a transition metal, L is an amino acid ligand, a is 1, c is 1 or 2, e is 1, 2, 3, 4, 5, 6, 7, or 8, the luminophore is selected from the group comprising: substituted and unsubstituted ninhydrin.

55. A compound made from the reaction of a metal chelate and a luminophore wherein the metal chelate is of the formula (Mₐ)^{e+}(L)_{c}, where M is a transition metal selected from the group comprising: zinc, iron, copper, and manganese, L is an amino acid ligand, a is 1, c is 1 or 2, e is 1, 2, 3, 4, 5, 6, 7, or 8, the luminophore is selected from the group comprising: ninhydrin, benzo[f]ninhydrin, benzo[f]furoninhydrin, 5-(4-nitrophenyl)ninhydrin, 5-methoxy-ninhydrin, 5-(methylthio)ninhydrin, thieno[f]ninhydrin, 5-(2-thienyl)ninhydrin, 5-(3-thienyl)ninhydrin, 1,8-diazaflourenone, ninhydrin, and benzoflavanon.

56. A method of assaying for the presence or absence of a metal-ligand complex in a sample comprising:
a. measuring a first electromagnetic spectrum of a ligand-luminophore reaction product in the absence of a metal at various concentrations;
b. reacting a metal-ligand chelate with a luminophore;
c. measuring a second electromagnetic spectrum of a ligand-luminophore reaction product from the metal-ligand chelate;
d. comparing the first electromagnetic spectrum with the second electromagnetic spectrum to detect a change.
